(19) United States
(12) Patent Application Publication
(10) Pub. No.: US 2024/0193626 A1
(43) Pub. Date: Jun. 13, 2024

(54) Vehicle Activity Clustering and Electric Charging Station Prediction Generation

(71) Applicant: Mercedes-Benz Group AG, Stuttgart (DE)

(72) Inventors: Francisco Cancino, South San Francisco, CA (US); Winston Ou, San Mateo, CA (US); Thomas Bilich, Menlo Park, CA (US)

(21) Appl. No.: 18/077,552

(22) Filed: Dec. 8, 2022

(51) Int. Cl. G06Q 30/0202

(52) U.S. Cl. CPC G06Q 30/0202

(57) ABSTRACT

A computing system may include a control circuit configured to receive: (i) vehicle location data indicating respective locations of vehicles during parking events respectively associated with the vehicles; and (ii) vehicle route data descriptive of a plurality of travel events associated with the vehicles. The control circuit is configured to generate, using a vehicle activity model and based on the vehicle location data and the vehicle route data, vehicle activity scores indexed by locations over the geographic region of interest. The control circuit is configured to generate, using an activity clustering model and based on the vehicle activity scores, vehicle activity clusters associated with respective points of interest. The control circuit is configured to generate, based on the vehicle activity clusters, a prediction associated with building an electric vehicle charging station at the respective points of interest.

### FIELD

The present disclosure relates generally to using vehicle activity metrics for clustering vehicle activity data within a given geographic region of interest and for generating electric charging station predictions for locations within the geographic region of interest.

### BACKGROUND

A vehicle, such as an automobile, has an onboard control system that generates vehicle data associated with operation of the vehicle. Vehicle data includes location data and other operational parameters associated with operation of the vehicle by an operator. Vehicle data aggregated over a plurality of vehicles in operation within a given geographic environment may provide useful insight for determination of vehicle-related metrics.

### SUMMARY

Aspects and advantages of implementations of the present disclosure will be set forth in part in the following description, or may be learned from the description, or may be learned through practice of the implementations.

One example aspect of the present disclosure is directed to a computing system for clustering vehicle activity data for vehicle activity within a geographic region of interest. The computing system may include a control circuit. The control circuit may be configured to receive vehicle location data indicating respective one or more locations of one or more vehicles during one or more parking events respectively associated with the one or more vehicles. The control circuit may be further configured to receive vehicle route data descriptive of a plurality of travel events associated with the one or more vehicles. The vehicle route data may indicate, for a respective travel event of the plurality of travel events, a respective origin and a respective destination. The control circuit may be further configured to generate, using a vehicle activity model and based on the vehicle location data and the vehicle route data, vehicle activity scores indexed by locations over the geographic region of interest. The vehicle activity model may describe a relationship between one or more vehicle parameters received as input and the vehicle activity scores provided as output, wherein the one or more vehicle parameters include the vehicle location data and the vehicle route data. The control circuit may be further configured to generate, using an activity clustering model and based on the vehicle activity scores, one or more vehicle activity clusters associated with respective one or more points of interest. The activity clustering model may describe a relationship between the vehicle activity scores received as input and the one or more vehicle activity clusters provided as output, wherein each vehicle activity cluster of the one or more vehicle activity clusters identifies a respective association of vehicle activities. The control circuit may be further configured to generate, based on the one or more vehicle activity clusters, a prediction associated with building an electric vehicle charging station at the one or more points of interest.

In an embodiment, the control circuit may be further configured to receive vehicle charging data associated with the geographic region of interest, and the vehicle activity model may be further configured to generate the vehicle activity scores based on the vehicle charging data.

In an embodiment, the vehicle charging data may be correlated with the vehicle location data.

In an embodiment, the locations by which the vehicle activity scores are indexed may include the one or more locations of the one or more vehicles during the one or more parking events.

In an embodiment, the locations by which the vehicle activity scores are indexed may include one or more respective locations of the one or more points of interest.

In an embodiment, the vehicle route data may be further indicative of a quantity of times that the plurality of travel events include travel between the respective origin and the respective destination.

In an embodiment, the control circuit may be further configured to receive vehicle range data associated with a battery range of the one or more vehicles, and the vehicle activity model may be further configured to generate the vehicle activity scores based on the vehicle range data.

In an embodiment, the activity clustering model may be further configured to generate the one or more vehicle activity clusters associated with the one or more points of interest by filtering the one or more points of interest based on a location of the one or more points of interest respectively being within a nearness threshold of a highway within the geographic region of interest.

In an embodiment, one or more vehicle activity clusters associated with one or more points of interest may be ranked by the control circuit based on the vehicle activity scores.

In an embodiment, the one or more points of interest may include at least one of a vehicle dealership location or a shopping location.

In an embodiment, the control circuit may be configured, when generating the one or more vehicle activity clusters associated with one or more points of interest, to determine a ranking of the respective one or more points of interest. The ranking of the respective one or more points of interest may be indicative of a desirability of building an electric vehicle charging station at the one or more points of interest.

In an embodiment, the vehicle activity model may be configured to generate the vehicle activity scores by fitting the vehicle activity scores to a normal distribution.

In an embodiment, the control circuit may be further configured to generate a heat map that provides a visualization of the geographic region of interest and map data associated with the one or more vehicle activity clusters associated with one or more of the points of interest.

Another example aspect of the present disclosure is directed to a computer-implemented method. The computer-implemented method may include receiving vehicle location data indicating respective one or more locations of one or more vehicles during one or more parking events respectively associated with the one or more vehicles. The computer-implemented method may also include receiving vehicle route data descriptive of a plurality of travel events associated with the one or more vehicles, the vehicle route data indicating, for a respective travel event of the plurality of travel events, a respective origin and a respective destination. The computer-implemented method may also include generating, using a vehicle activity model and based on the vehicle location data and the vehicle route data, vehicle activity scores indexed by locations over the geographic region of interest. The vehicle activity model may describe a relationship between one or more vehicle parameters received as input and the vehicle activity scores provided as output, wherein the one or more vehicle parameters include the vehicle location data and the vehicle route data. The computer-implemented method may also include generating, using an activity clustering model and based on the vehicle activity scores, one or more vehicle activity clusters associated with respective one or more points of interest. The activity clustering model may describe a relationship between the vehicle activity scores received as input and the one or more vehicle activity clusters provided as output. Each vehicle activity cluster of the one or more vehicle activity clusters may identify a respective association of vehicle activities. The computer-implemented method may also include generating, based on the one or more vehicle activity clusters, a prediction associated with building an electric vehicle charging station at the one or more points of interest.

In an embodiment, the computer-implemented method may also include receiving vehicle charging data associated with the geographic region of interest. The vehicle activity model may be further configured to generate the vehicle activity scores based on the vehicle charging data.

In an embodiment, the vehicle charging data may be correlated with the vehicle location data.

In an embodiment, the locations by which the vehicle activity scores are indexed may include the one or more locations of the one or more vehicles during the one or more parking events.

In an embodiment, the locations by which the vehicle activity scores are indexed may include one or more respective locations of the one or more points of interest.

In an embodiment, the computer-implemented method may also include receiving vehicle range data associated with a battery range of the one or more vehicles. The vehicle activity model may be further configured to generate the vehicle activity scores based on the vehicle range data.

Yet another example aspect of the present disclosure is directed to one or more non-transitory computer-readable media that store instructions that are executable by a control circuit. The instructions, when executed, may cause the control circuit to perform operations. The operations may include receiving vehicle location data indicating respective one or more locations of one or more vehicles during one or more parking events respectively associated with the one or more vehicles. The operations may further include receiving vehicle route data descriptive of a plurality of travel events associated with the one or more vehicles, the vehicle route data indicating, for a respective travel event of the plurality of travel events, a respective origin and a respective destination. The operations may further include generating, using a vehicle activity model and based on the vehicle location data and the vehicle route data, vehicle activity scores indexed by locations over the geographic region of interest. The vehicle activity model may describe a relationship between one or more vehicle parameters received as input and the vehicle activity scores provided as output, wherein the one or more vehicle parameters include the vehicle location data and the vehicle route data. The operations may further include generating, using an activity clustering model and based on the vehicle activity scores, one or more vehicle activity clusters associated with respective one or more points of interest. The activity clustering model may describe a relationship between the vehicle activity scores received as input and the one or more vehicle activity clusters provided as output. Each vehicle activity cluster of the one or more vehicle activity clusters may identify a respective association of vehicle activities. The operations may further include generating, based on the one or more vehicle activity clusters, a prediction associated with building an electric vehicle charging station at the one or more points of interest.

Other example aspects of the present disclosure are directed to other systems, methods, vehicles, apparatuses, tangible non-transitory computer-readable media, and devices for improving the determination of vehicle activity scores and clusters and generation of related electric charging station predictions associated with vehicle operation.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example computing ecosystem according to example embodiments hereof.

FIG. 2 depicts a diagram of an example computing system architecture according to example embodiments hereof.

FIG. 3 depicts a diagram of an example vehicle activity system according to example embodiments hereof.

FIG. 4 depicts a diagram of an example activity clustering system according to example embodiments hereof.

FIG. 5 depicts a diagram of an example charging activity prediction system according to example embodiments hereof.

FIG. 6 depicts an example ranking of activity clusters associated with points of interest according to example embodiments hereof.

FIGS. 7-11 depict various example output maps according to example embodiments hereof.

FIG. 12 depicts a flowchart diagram of an example method for clustering vehicle activity data for vehicle activity within a geographic region of interest according to example embodiments hereof.

FIG. 13 depicts a flowchart diagram of an example method for generating vehicle activity scores according to example embodiments hereof.

FIG. 14 depicts a flowchart diagram of an example method for generating vehicle activity clusters according to example embodiments hereof.

FIG. 15 depicts an example computing system overview for training a machine-learned model according to example embodiments hereof.

### DETAILED DESCRIPTION

One aspect of the present disclosure relates to using improved vehicle data models to generate predictions associated with the placement of electric vehicle charging stations within a given geographic region. As the number of electric vehicles continues to increase in worldwide operation, strategic development of charging station infrastructure may be beneficial for numerous entities. The disclosed technology provides dynamic metrics capable of generating predictions and associated output data on a region-specific basis. For instance, a geographic region of interest may correspond to one or more specific continents, countries, states, towns, municipalities, zip codes, or other defined regions. Because infrastructure needs often vary from one region to another, it may be beneficial to generate custom predictions for unique regions.

For example, a computing system (e.g., a cloud-based server system) can be configured to analyze data from various sources and determine charging activity. The computing system can receive vehicle data (e.g., vehicle data that maintains operator privacy), which may be gathered from one or more vehicles operating within a given geographic region of interest. In an embodiment, the computing system may receive additional or alternative data from one or more associated databases. For example, additional data may include map data, point of interest data, and/or charging station data. The computing system may include one or more vehicle models (e.g., a vehicle activity model, an activity clustering model, and/or a charging activity prediction model) configured to process the vehicle data and generate one or more charging activity outputs. The charging activity outputs may provide be used for strategic planning for placement and/or use of electric vehicle charging stations within the given geographic region of interest.

More particularly, the computing system may receive different types of vehicle data from the one or more vehicles operating within the given geographic region of interest. The one or more vehicles may be associated with a given entity (e.g., a given vehicle manufacturer) or with multiple entities (e.g., a first-party vehicle manufacturer and one or more third-party vehicle manufacturers). The one or more vehicles may be electric vehicles (EVs) and/or non-electric vehicles.

The vehicle data may include vehicle location data indicating one or more locations of the one or more vehicle during operation. For instance, the vehicle location data may be indicative of respective locations of the one or more vehicles during one or more parking events associated with the vehicles. Vehicle location data associated with parking events may provide a proxy for vehicle movement without tracking active movement of the vehicles.

The vehicle data may additionally, or alternatively, include vehicle route data descriptive of a plurality of travel events associated with the vehicles. The vehicle route data may indicate, for a respective travel event of the plurality of travel events, a respective origin and a respective destination. In some instances, the vehicle route data may provide one or more measures associated with the travel events. In an example, the measures associated with the travel events may include a quantity of times that the plurality of travel events include travel between the respective origin and the respective destination.

The vehicle data may additionally, or alternatively, include vehicle charging data associated with the geographic region of interest. For example, the vehicle charging data may be indicative of charging events associated with the one or more vehicles operating within the geographic region of interest. Example vehicle charging data may include data associated with historic and/or current charging activity. For example, the vehicle charging data may include timestamps indicative of when charging occurred, location data indicative of where charging occurred, charge rate data indicative of how fast charging occurred, charging metrics that combine one or more of these aspects in a cumulative manner (e.g., to determine frequencies or rankings or charging activity data), etc. In some instances, the vehicle charging data may be correlated with the vehicle location data (e.g., for parking events that are also characterized as vehicle charging events). The vehicle charging data may additionally, or alternatively, include vehicle range data associated with a battery range of the one or more vehicles. The vehicle charging data may additionally, or alternatively, include a total battery charging capacity, a current battery charge level, an expected time left until recharging is needed, or other real-time vehicle charging data parameters associated with a particular vehicle

The additional data from the associated databases may include one or more of: (i) map data; (ii) point of interest (POI) data; and (iii) charging station data. The map data may include location and/or position information (e.g., GPS coordinates, latitude/longitude data) and/or graphical visualization data associated with the geographic region of interest. The point of interest data may include identifiers and information (e.g., location data) associated with the points of interest within the geographic region of interest. Example POIs may include vehicle dealerships and/or shopping establishments such as supermarkets, furniture stores, and the like. The charging station data may be indicative of locations of existing electric vehicle charging station locations (e.g., first-party and/or third-party charging stations) within the given geographic region of interest.

The computing system may include a vehicle activity model that describes a relationship between one or more vehicle parameters received as input and one or more vehicle activity scores generated as output. The one or more vehicle parameters can include vehicle data gathered from or determined based on vehicles operating within a geographic region of interest, for example, vehicle location data, vehicle route data, vehicle charging data, etc. The computing system may also generate, using the vehicle activity model, vehicle activity scores indexed by locations (e.g., locations of the vehicles during the parking events and/or locations of one or more points of interest) over the geographic region of interest. The vehicle activity scores can be a measure that represents or otherwise quantifies vehicle operational activity in the geographic region of interest.

The computing system may include an activity clustering model that describes a relationship between the vehicle activity scores received as input and one or more vehicle activity clusters provided as output. Each vehicle activity cluster of the one or more vehicle activity clusters may identify a respective association of vehicle activities. The activity clustering model may be configured to generate, using the activity clustering model and based on the vehicle activity scores, one or more vehicle activity clusters associated with respective one or more points of interest.

The computing system may include a charging activity prediction model that is configured to generate one or more charging activity outputs. One example charging activity output may provide a prediction associated with building a new electric vehicle charging station at the one or more points of interest. For example, a prediction associated with building a new electric vehicle charging station may be indicative of how much a charging station will be used if it is built at a particular location (e.g., a location of a point of interest for co-location with a new charging station). Another example charging activity output may provide a prediction associated with charging an electric vehicle at an existing electric vehicle charging station. For example, a prediction associated with charging an electric vehicle may be indicative of historic demand associated with a charging station, real-time or current availability at a charging station, and/or likelihood of utilization for a next charging activity at a charging station. Example charging activity outputs may additionally, or alternatively, include one or more map outputs. The map outputs may include, for example, a heat map output that provides a visualization of the geographic region of interest and/or map data associated with the one or more vehicle activity clusters associated with one or more of the points of interest.

The technology of the present disclosure provides a number of technical effects and improvements to vehicle activity analytics and charging infrastructure planning and deployment for electric vehicles. For instance, vehicle activity models, activity clustering models, and/or charging activity prediction models may be tailored to specific geographic regions by gathering region-specific vehicle data for analysis and prediction generation. In addition, vehicle location data provided to such models may be associated with passive events such as parking, as opposed to active movement, thereby affording greater security for vehicle operator data. The models described herein may be trained and retrained as new vehicle data sources become available to increase prediction certainty associated with building new electric vehicle charging stations.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

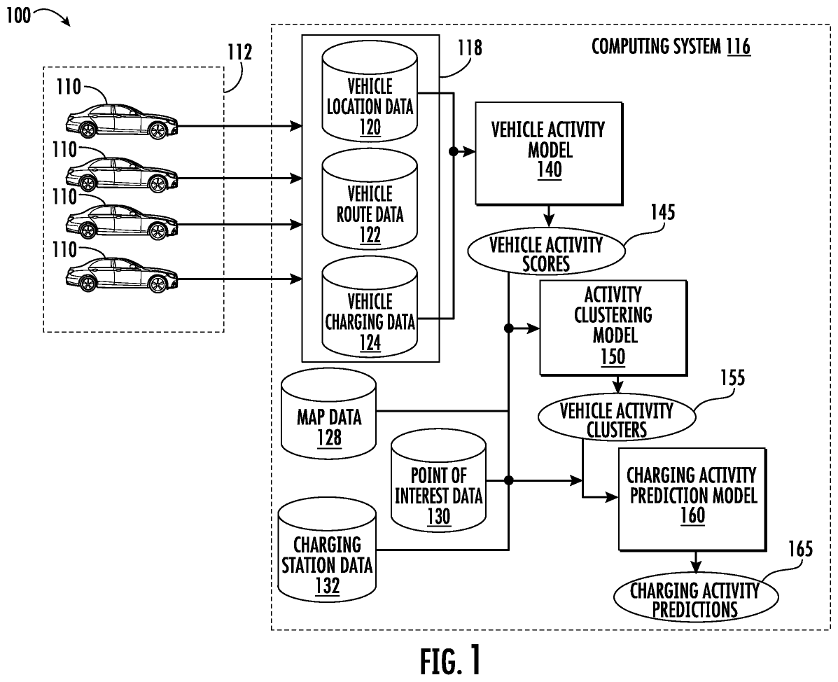

FIG. 1 depicts an example computing ecosystem 100 according to example embodiments hereof. The ecosystem 100 may include one or more vehicles 110 operating within a given geographic region of interest 112 and a computing system 116.

The vehicles 110 may be associated with a given entity (e.g., a given vehicle manufacturer) or with multiple entities (e.g., a first-party vehicle manufacturer and one or more third-party vehicle manufacturers). The vehicles 110 may be electric vehicles (EVs) and/or non-electric vehicles. The vehicles 110 may be vehicles that are operable by an operator. For instance, the vehicles 110 may be an automobile or another type of ground-based vehicle that may be manually driven by the operator. In some implementations, the vehicles 110 may be an aerial vehicle or water-based vehicle such as a personal airplane or boat. The vehicles 110 may include operator-assistance functionality such as cruise control, advanced driver assistance systems, etc. In some implementations, the vehicles 110 may be fully or semi-autonomous vehicles. In an aspect, the vehicles 110 may respectively be a human-operated vehicle, a semi-autonomous vehicle, an autonomous vehicle, and/or any other suitable vehicle. In an aspect, the vehicles 110 may be commercially available consumer vehicles. Routine and conventional components of vehicles 110 (e.g., an engine, passenger seats, windows, tires and wheels, etc.) are not illustrated and/or discussed herein for the purpose of brevity. One of ordinary skill in the art will understand the operation of conventional vehicle components in vehicles 110.

The vehicles 110 may include a power train and one or more power sources. The power train may include a motor/e-motor, transmission, driveshaft, axles, differential, power electronics, gear, etc. The power sources may include one or more types of power sources. For example, the vehicles 110 may be fully electric vehicles (EVs) that are capable of operating a powertrain of the vehicle 110 and the vehicle's onboard functionality using electric batteries. In an embodiment, the vehicles 110 may be capable of using combustible fuel. In an embodiment, the vehicles 110 may include hybrid propulsion systems such as, for example, a combination of combustible fuel and electricity.

The vehicles of FIG. 1 may operate or have operated within a given geographic region of interest 112. The geographic region of interest 112 may correspond to one or more specific continents, countries, states, towns, municipalities, zip codes, or other defined regions.

The computing system 116 may receive different types of vehicle data 118 from the one or more vehicles 110 operating within the geographic region of interest 112. For example, vehicle data 118 may include at least one portion of location data that maintains operator privacy by focusing on passive location data as opposed to active motion tracking. In an embodiment, vehicle data 118 includes basic vehicle identifier information, such as vehicle type, vehicle size, vehicle class, vehicle battery type and corresponding range data, or other identification of function information associated with the one or more vehicles 110.

In an embodiment, the vehicle data 118 may include vehicle location data 120 indicating locations of the vehicles 110 during operation. For instance, the vehicle location data 120 may be indicative of locations of the vehicles 110 during one or more parking events associated with the vehicles 110. Vehicle location data 120 associated with parking events may provide a proxy for vehicle movement without tracking active movement thereof.

The vehicle data 118 may additionally, or alternatively, include vehicle route data 122 descriptive of a plurality of travel events associated with the vehicles 110. The vehicle route data 122 may indicate, for a respective travel event of the plurality of travel events, a respective origin and a respective destination. In some instances, the vehicle route data 122 may provide one or more measures associated with the travel events. In an embodiment, vehicle route data may include a frequency or quantity of times that the plurality of travel events include travel between the respective origin and the respective destination. As an example, consider that vehicles 110 travel in a geographic region of interest 112 that includes three towns: Town A, Town B, and Town C. Vehicle route data 122 may include: (i) a quantity of times that vehicles 110 have traveled between Town A and Town B within a given period of time; (ii) a quantity of times that vehicles 110 have traveled between Town B and Town C within the given period of time; and (iii) a quantity of times that vehicles 110 have traveled between Town A and Town C during the given period of time.

The vehicle data 118 may additionally, or alternatively, include vehicle charging data 124 associated with the geographic region of interest 112. For example, the vehicle charging data 124 may be indicative of charging events associated with the one or more vehicles 110 operating within the geographic region of interest 112. In some instances, the vehicle charging data 124 may be correlated with the vehicle location data 120 (e.g., for parking events that are also characterized as vehicle charging events). The vehicle charging data 124 may additionally, or alternatively, include vehicle range data associated with a battery range of the one or more vehicles 110.

Additional, or alternative, data may be provided from one or more associated databases that are co-located with computing system 116 or otherwise accessible by computing system 116. The computing system 116 may receive the vehicle data 118 and may also receive the additional data from the associated databases. The additional data from the associated databases may include one or more of: (i) map data 128; (ii) point of interest data 130; and (iii) charging station data 132. The map data 128 may include location and/or position information (e.g., GPS coordinates, latitude/longitude data) and/or graphical visualization data associated with the geographic region of interest 112. The point of interest data 130 may include identifiers and information (e.g., location data) associated with the points of interest (POIs) within the geographic region of interest 112. Example POIs may include vehicle dealerships and/or shopping establishments such as supermarkets, furniture stores, and the like. The charging station data 132 may be indicative of locations of existing electric vehicle charging station locations (e.g., first-party and/or third-party charging stations) within the given geographic region of interest 112.

The computing system 116 may include one or more vehicle models configured to process the vehicle data 118 and ultimately generate one or more charging activity outputs 165. The charging activity outputs 165 may provide strategic planning for placement and/or use of electric vehicle charging stations within the given geographic region of interest 112, as further described herein. The vehicle models may include a vehicle activity model 140, an activity clustering model 150, and/or a charging activity prediction model 160.

The computing system 116 may include a vehicle activity model 140 that describes a relationship between one or more vehicle parameters (e.g., vehicle location data 120, vehicle route data 122, and/or vehicle charging data 124) received as input and a vehicle activity metric (e.g., one or more vehicle activity scores 145) as output. That is, the one or more vehicle parameters may be input to the vehicle activity model 140 in this example, and the vehicle activity metric may be an output of the vehicle activity model 140. A vehicle parameter may be a parameter which describes where the vehicle has traveled to, parked at, charged at, or how the vehicle has been charged. In an embodiment, each of the one or more vehicle parameters is at least one of: a vehicle location parameter (which is described by vehicle location data 120), a vehicle route parameter (which is described by vehicle route data 122), or a vehicle charging parameter (which is described by vehicle charging data 124).

The vehicle activity metric (e.g., vehicle activity scores 145) generated by vehicle activity model 140 may be a standard of measuring vehicle activity, including one or more of a level of vehicle movement, a level of vehicle stopping (e.g., for parking and/or charging events), a level of traveling to particular destination locations, or level of other vehicle activity. In an embodiment, the vehicle activity metric includes one or more vehicle activity scores, although other measures may be utilized such as but not limited to categories, rankings, ratings, and the like. The computing system 116 may be configured to generate, using the vehicle activity model 140 and based on the vehicle location data 120, vehicle route data 122, vehicle charging data 124, and/or vehicle activity scores 145 indexed by locations (e.g., locations of the vehicles 110 during the parking events and/or locations of one or more points of interest) over the geographic region of interest 112. In such example, if the vehicle activity scores are indexed by a location, then the score indicates a level of activity of the vehicle at that location or a geographic area defined to encompass that location.

The computing system 116 may include an activity clustering model 150 that describes a relationship between the vehicle activity scores 145 received as input and one or more vehicle activity clusters 155 provided as output. The activity clustering model 150 may be configured to generate, using the activity clustering model 150 and based on the vehicle activity scores 145, one or more vehicle activity clusters 155 associated with respective one or more points of interest. Each vehicle activity cluster 155 of the one or more vehicle activity clusters 155 may identify a respective association of vehicle activities. For example, the computing system 116 can process the vehicle activity scores 145 to group similar data points together and distinguish dissimilar data points. In an embodiment, a given point of interest is considered a centroid of an activity cluster, and parking events or other vehicle activity events within a threshold distance (e.g., 2 km) of the given point of interest are clustered together into a vehicle activity cluster 155. In an embodiment, a Haversine distance metric may be employed to determine parking events or other vehicle activity events that are within the threshold distance from a POI or other centroid.

The computing system 116 may include a charging activity prediction model 160 that is configured to generate one or more charging activity outputs 165. One example charging activity output 165 may provide a prediction associated with building a new electric vehicle charging station at the one or more points of interest. Another example charging activity output 165 may provide a prediction associated with charging an electric vehicle at an existing electric vehicle charging station. For instance, charging activity prediction model may include multiple machine-learned models configured to generate a charging station recommendation for a vehicle operator. A first model may be trained to learn a vehicle operator's charging preferences (e.g., likely to charge in the next 20 miles when battery falls below a certain threshold charge level). A second model may be trained to generate a charging station recommendation (e.g., a charging station identifier, location, and/or navigation directions) based on the user-specific preferences determined from the first model. Example charging activity outputs may additionally, or alternatively, include one or more map outputs. In an example, the map outputs may include a heat map output that provides a visualization of the geographic region of interest and/or map data associated with the one or more vehicle activity clusters associated with one or more of the points of interest.

Computing system 116 may include additional application models that are configured to generate one or more additional or alternative outputs based on the vehicle activity scores 145 and/or vehicle activity clusters 155. In an embodiment, computing system 116 may be configured to generate an advertisement output that targets relevant advertising content in the form of a notification, image or video displaying product or service information, promotions, coupons, or other marketing material to a vehicle driver or passenger (e.g., by a display device associated with on-board computing system 210) based on the vehicle activity scores and/or clusters. In another embodiment, computing system 116 may be configured to generate context data that provides additional information determined from or associated with the vehicle activity and vehicle clustering data. For example, if vehicle activity data and vehicle clustering data are intentionally based on parking data that does not include active vehicle movement, additional context data may predict aspects of active movement from the parking events.

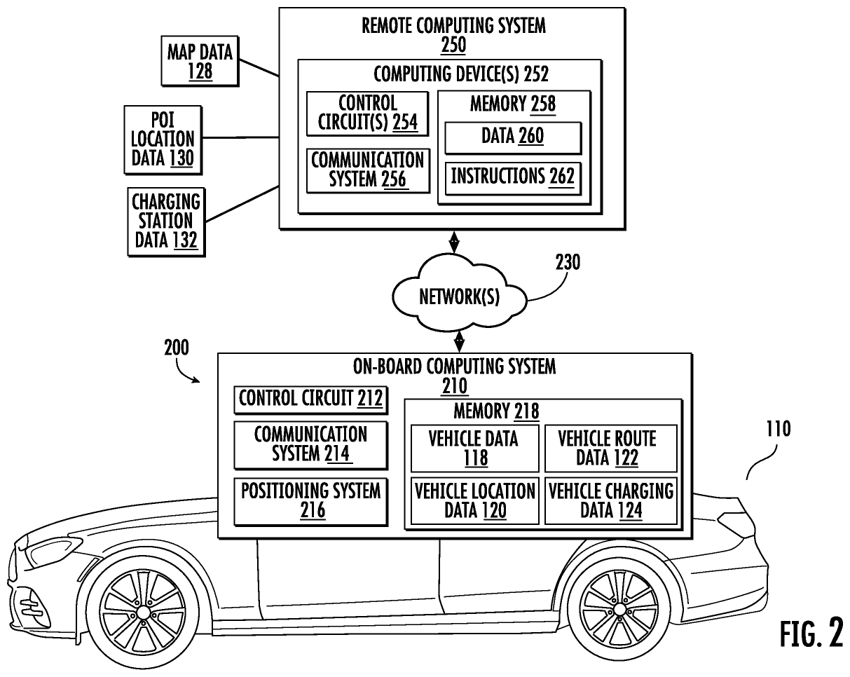

FIG. 2 depicts a diagram of an example computing system architecture 200 according to example embodiments hereof Computing system architecture 200 may include an on-board computing system 210 and a remote computing system 250. In an embodiment, an on-board computing system 210 is provided as part of respective vehicles 110 illustrated in FIG. 1. In an embodiment, remote computing system 250 corresponds to computing system 116 of FIG. 1. On-board computing system 210 and remote computing system 250 may be in communication with one another over network 230.

The on-board computing system 210 may be configured to perform some or all operations for collection and/or determination of vehicle data 118. Vehicle data 118 may then be aggregated at remote computing system 250 over a plurality of vehicles 110 operating within a geographic region of interest. The on-board computing system 210 may include a control circuit 212, a communication system 214, a positioning system 216, and a memory 218.

In an embodiment, the control circuit 212 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 212 and/or on-board computing system 210 may be part of, or may form, a vehicle control unit (also referred to as a vehicle controller) that is embedded or otherwise disposed in the vehicle 110 (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller (the term “or” and “and/or” may be used interchangeably herein).

In an embodiment, the communication system 214 may be configured to function as a communication interface used to communicate with one or more systems or devices, including systems or devices that are remotely located from the on-board computing system 210. The communication system 214 may include any circuits, components, software, etc. for communicating with one or more networks (e.g., network 230). In some implementations, the communication system 214 may include, for example, one or more of a communications controller, receiver, transceiver, transmitter, port, conductors, software or hardware for communicating data.

The network 230 may be any type of network or combination of networks that allows for communication between devices. In an embodiment, the network 230 may include one or more of a local area network, wide area network, the Internet, secure network, cellular network, mesh network, peer-to-peer communication link or some combination thereof and may include any number of wired or wireless links. Communication over the network 230 may be accomplished, for instance, via a network interface using any type of protocol, protection scheme, encoding, format, packaging, etc.

In an embodiment, the on-board computing system 210 may include a non-transitory computer-readable medium 218, also referred to as memory 218. The non-transitory computer-readable medium 218 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 218 may store computer-executable instructions or computer-readable instructions, such as instructions to perform data determination for storage as vehicle data 118 of FIG. 1.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 212 to perform one or more functional tasks. The modules and computer-readable/executable instructions may be described as performing various operations or tasks when a control circuit or other hardware component is executing the modules or computer-readable instructions.

In an embodiment, the memory 218 may store vehicle data 118 that describes aspects of the vehicle 110, such as make, model, year, serial number, software/firmware versions, and/or other vehicle aspects. In an embodiment, the vehicle data 118 stored in memory 218 may also include vehicle location data 120, vehicle route data 122, and vehicle charging data 124, as previously described with reference to FIG. 1.

The vehicle location data 120 stored in memory 218 may be determined in part from sensor output associated with positioning system 216. The positioning system 216 may be any suitable positioning system and/or combinations thereof. As one example, the positioning system 216 may be or may include a satellite positioning system, such as GPS or GLONASS. As another example, the positioning system 216 may output position data describing geographic coordinates (e.g., latitude/longitude) or more granular locations (e.g., travelway segments and/or parking area locations at which the vehicle 110 is located or positioned within. For instance, the positioning system 216 may compare coordinates (e.g., satellite coordinates) of the vehicle 110 to coordinates associated with travelway segments or parking area partitions to identify which segments/partitions the vehicle 110 is positioned within. Additionally, and/or alternatively, the positioning system 216 may utilize computer vision techniques, such as lane recognition techniques, to identify which lane and/or segment of a travelway the vehicle 110 is positioned within.

The vehicle route data 122 stored in memory 218 may be determined, similar to vehicle location data 120, from positioning system 216. In addition, vehicle route data 122 may also be obtained from one or more navigational systems provided onboard vehicle 110. In an embodiment, on-board computing system 210 and/or remote computing system 250 may process vehicle location data 120 or other vehicle data 118 to determine the vehicle route data 122 including travel events and associated origins and destinations thereof.

The vehicle charging data 124 stored in memory 218 may be predetermined or may be determined, at least in part, by communication of the on-board computing system 210 with one or more electric batteries provided within the vehicle 110. In such manner, the on-board computing system 210 may periodically monitor respective electric batteries to determine a total charging capacity, a current battery charge level, an expected time left until recharging is needed, or other real-time vehicle charging data parameters associated with a particular vehicle 110. The vehicle charging data 124 may additionally, or alternatively, include data associated with historic and/or current charging activity. For example, the vehicle charging data may include timestamps indicative of when charging occurred, location data indicative of where charging occurred, charge rate data indicative of how fast charging occurred, charging metrics that combine one or more of these aspects in a cumulative manner (e.g., to determine frequencies or rankings or charging activity data), etc.

In an embodiment, the on-board computing system 210 may process the vehicle data 118, including vehicle location data 120, vehicle route data 122 and/or vehicle charging data 124 to remove private information, such as but not limited to active movement of vehicle 110 when not permitted by an operator of vehicle 110. The on-board computing system 210 may additionally process the vehicle data 118, including vehicle location data 120, vehicle route data 122 and/or vehicle charging data 124 to remove any private information (e.g., vehicle owner, vehicle operator, active locations, etc.) before any of the data, encrypted or otherwise, is transmitted off of the vehicle 110 and/or used in any meaningful way. Thus, the vehicle 110 may preserve the privacy of its occupants as well as surrounding persons.

Referring still to FIG. 2, on-board computing system 210 may be communicatively coupled to one or more remote computing systems 250 over one or more networks 230. Remote computing system 250 may include one or more computing devices 252, which may respectively include a control circuit 254, a communication system 256, and a memory 258. The control circuit 254 may include one or more processors or any suitable processing device (e.g., a processor core, a microprocessor, an ASIC, a FPGA, a controller, a microcontroller, etc.) and may be one processor or a plurality of processors that are operatively connected. The memory 258 may include one or more non-transitory computer-readable storage media, such as RAM, ROM, EEPROM, EPROM, one or more memory devices, flash memory devices, etc., and combinations thereof.

The memory 258 may store information that may be accessed by the control circuit 254. For instance, the memory 258 (e.g., one or more non-transitory computer-readable storage mediums, memory devices) may store data 260 that may be obtained, received, accessed, written, manipulated, created, or stored. The data 260 may include, for instance, data obtained from the on-board computing system 210 such as but not limited to vehicle data 118, vehicle location data 120, vehicle route data 122, and/or vehicle charging data 124. The data may additionally include data received from other databases such as but not limited to map data 128, POI data 130 and/or charging station data 132. In some implementations, the remote computing system 250 may obtain data from one or more memory devices that are remote from the remote computing system 250.

The memory 258 may also store computer-readable instructions 262 that may be executed by the control circuit 254. The instructions 262 may be software written in any suitable programming language or may be implemented in hardware. Additionally, or alternatively, the instructions 262 may be executed in logically or virtually separate threads on control circuit 254.

For example, the memory 258 may store instructions 262 that when executed by the control circuit 254 cause the control circuit 254 (the remote computing system 250) to perform any of the operations or functions described herein, including, for example, obtaining/receiving various forms of vehicle data 118 or other data and processing such data using one or more of the models described with reference to FIG. 1 (e.g., vehicle activity model 140, activity clustering model 150 and/or charging activity prediction model 160).

The remote computing system 250 may include a communication system 256. The communication system 256 may be used to communicate with one or more systems or devices, including systems or devices that are remotely located from the remote computing system 250. The communication system 256 may include any circuits, components, software, etc. for communicating with one or more networks (e.g., network 230). In some implementations, the communication system 256 may include, for example, one or more of a communications controller, receiver, transceiver, transmitter, port, conductors, software or hardware for communicating data.

FIG. 2 illustrates one example computing system architecture 200 that may be used to implement the present disclosure. Other computing systems may be used as well. In addition, components illustrated or discussed as being included in one of the computing systems 210, 250 may instead be included in any other suitable computing system. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

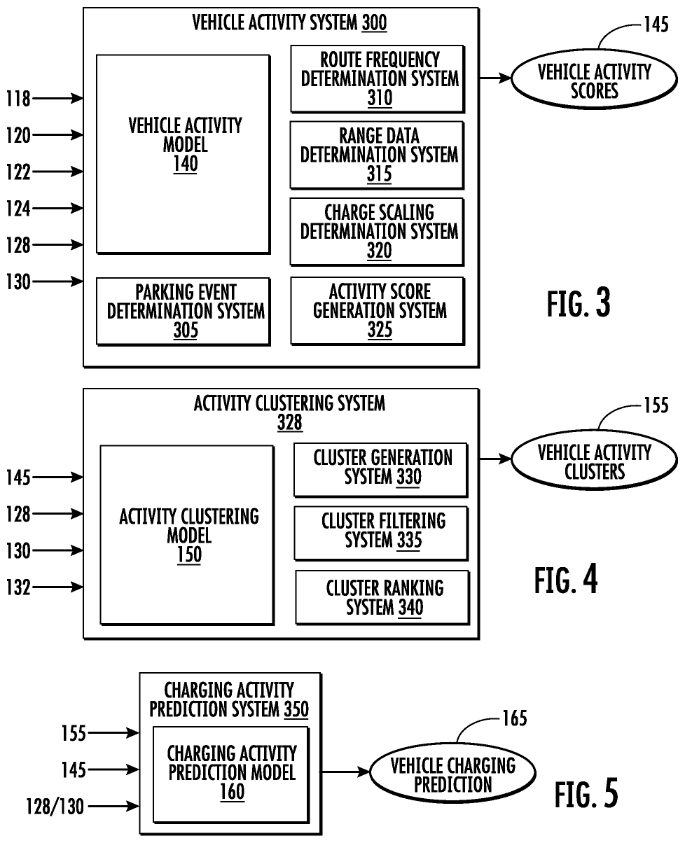

Referring now to FIGS. 3-5, exemplary aspects of vehicle activity model 140, activity clustering model 150, and charging activity prediction model 160 of FIG. 1 will be described in additional detail. It should be appreciated that although such models are described herein as three separate models, computing system 116 of FIG. 1 and/or remote computing system 250 of FIG. 2 may include a fewer or greater number of models that are integrated or expanded to perform the same or similar functionality as models 140, 150, and 160. For example, a single model may be configured to perform the operations of both vehicle activity model 140 and activity clustering model 150 by processing vehicle data 118, map data 128, point of interest data 130, and/or charging station data 132 to directly generate vehicle activity clusters 155. Alternatively, a single model may be configured to perform the operations of vehicle activity model 140, activity clustering model 150, and charging activity prediction model 160 by processing vehicle data 118, map data 128, point of interest data 130, and/or charging station data 132 to directly generate charging activity outputs 165.

FIG. 3 depicts a diagram of an example vehicle activity system 300 according to example embodiments hereof. The vehicle activity system 300 may be implemented, for example, in computing system 116, on-board computing system 210, and/or remote computing system 250. The vehicle activity system 300 may include vehicle activity model 140. The vehicle activity model 140 may describe a relationship between one or more vehicle parameters (e.g., vehicle location data 120, vehicle route data 122, and/or vehicle charging data 124) received as input and a vehicle activity metric (e.g., one or more vehicle activity scores 145) generated as output. In an embodiment, vehicle activity model 140 may be or may include a rules-based algorithm embodied in computer code commands. In another embodiment, vehicle activity model 140 may be or may otherwise include various machine-learned models such as neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

The vehicle activity model 140 may be configured to implement (e.g., generate) a vehicle activity metric, such as one or more vehicle activity scores, rankings, ratings, or other measures of vehicle activity. The vehicle activity metric generated by vehicle activity model 140 may be generally based on a combination of short distance vehicle activity and long distance vehicle activity. The short distance and/or long distance vehicle activity may include parking events as determined from vehicle location data 120, highly frequented routes traveled as determined from vehicle route data 122, highway infrastructure GPS points as determined from map data 128, and/or electric vehicle range data as determined from vehicle charging data 124. Vehicle activity model 140 may be configured to include, access, or otherwise leverage a parking event determination system 305, a route frequency determination system 310, a range data determination system 315, a charge scaling determination system 320, and a vehicle activity score generation system 325. In an embodiment, one or more of these systems can be implemented as one or more portions, components, layers, or sub-models of the vehicle activity model 140. Additionally, or alternatively, one or more one or more of these systems can be implemented as systems that are separate, accessible systems.

The parking event determination system 305 may be configured to conduct a time-based analysis of the vehicle location data 120 to determine one or more parking events for one or more vehicles 110 operating within a given geographic region of interest 112. The parking event determination system 305 may determine one or more parking events by identifying locations at which a vehicle 110 has stopped moving for greater than a threshold time duration. The threshold time duration may be a quantity of hours, minutes, and/or seconds during which the vehicle 110 is not actively moving. The parking event determination system 305 may determine parking events additionally, or alternatively, based on a determination of a vehicle position being within an area known to correspond to a parking area (e.g., parking lot, parking garage, areas close to shopping locations but not on travelways, etc.). For instance, parking event determination system 305 may receive location data from position system 216 of vehicle 110 and then compare it to a map data structure (e.g., from map data 128) that indicates designated parking areas. In the event the vehicle location data is within a coordinate range defining a designated parking area or within a threshold distance of a centroid defining a parking area, then parking event determination system 305 can designate occurrence of a parking event. The parking event determination system 305 may be configured to determine a location-based identifier (GPS coordinates, latitude/longitude, nearest point of interest, etc.) for respectively identified parking events. In some embodiments, the parking event determination system 305 may be configured to determine one or more time stamps or time durations associated with the parking event (e.g., a length of time during which a vehicle 110 has stopped actively moving). In an example, the location-based identifier and/or the timestamp can be used for indexing the parking events in data structure stored in a memory.

The parking event determination system 305 may be further configured to determine a number of parking events associated with different portions of a given geographic region of interest. For example, the geographic region of interest 112 may be partitioned into different discrete regions (e.g., a grid of polygons corresponding to one or more particular shapes and/or corresponding sizes). The geographic region of interest 112 may be partitioned into regions based on points of interest within the geographic region of interest 112. A partitioned region may be defined by a radius surrounding respective points of interest, such as points of interest defined within point of interest data 130. For instance, a geographic region of interest may correspond to distinct regions corresponding to an X-distance radius around respective points of interest within the region. The X-distance radius may be measured in terms of any particular distance dimension, such as meters (m), kilometers (km), feet (ft.), yards (yds.), miles (mi.), etc. The specific number X-distance of meters defining a radius around each point of interest may be fixed across the region or may vary, for example, based on density of vehicles, points of interest, travelways, or other infrastructure within the region. The distance value X defining a radius around each point of interest may be a specific value (e.g., 10 meters, 100 meters, 500 meters, 1 km) or may be indicative of a specific range, for example, between 0 meters and 1000 meters, between 1 meter and 10 meters, between 5 meters and 100 meters, or other specific ranges. Parking event determination system 305 may be configured to determine a number of parking events occurring within the radius or radius range defined around respective points of interest within the given geographic region of interest. As a result, the parking event determination system 305 may determine a number of parking events associated with different regions grouped by a GPS latitude/longitude coordinate rounded to a nearest decimal place (e.g., 4 decimal places).

The route frequency determination system 310 may be configured to analyze the vehicle route data 122 to help identify travel events. More particularly, the route frequency determination system 310 can extract or determine certain information from the vehicle route data 122. This can include, for example, the extraction (or determination) of data descriptive of a plurality of travel events associated with the one or more vehicles 110. The data descriptive of the plurality of travel events may include, for example, a respective origin and a respective destination for each travel event. Route frequency determination system 310 may be configured to determine data indicative of a quantity of times that the plurality of travel events include travel between the respective origin and the respective destination. For example, as described herein, given a particular point of interest located in Town A, route frequency determination system 310 may be configured to determine a frequency or quantity of times that vehicles 110 have traveled between Town A and other towns (e.g., Town B, Town C, . . . Town N) within a geographic region of interest. Consideration of route frequency between a current city and other nearby cities may serve as a useful indicator contributing to the overall vehicle activity metric generated by vehicle activity model 140.

The range data determination system 315 may be configured to analyze the vehicle charging data 124 to help identify vehicle charging events and/or vehicle range data. More particularly, the range data determination system 314 can extract or determine certain information from the vehicle charging data 124. This can include, for example, the extraction (or determination) or data descriptive of charging events associated with the one or more vehicles 110 operating within the geographic region of interest 112. In some instances, the vehicle charging data 124 may be correlated with the vehicle location data 120 (e.g., for parking events that are also characterized as vehicle charging events). The vehicle charging data 124 may additionally, or alternatively, include vehicle range data associated with a battery range of the one or more vehicles 110.

The charge scaling determination system 320 may be configured to combine and scale respective outputs from the parking event determination system 305, route frequency determination system 310, and/or range data determination system 315. Charge scaling determination system 320 may be configured to determine a parameter combination of vehicle data. For example, the parameter combination of vehicle data can correspond to a combination of (e.g., a sum of): (i) a number of parking events per portion of the geographic region of interest as determined by parking event determination system 305; (ii) a number of times a route between a current (origin) location (e.g., city) and other (destination) locations (e.g., cities) are traveled as determined by route frequency determination system 310; and (iii) a number of times an EV is within an approximate portion of a geographic region of interest (e.g., a 10-meter radius of a point of interest) based on a battery range of the EV as determined by the range data determination system 315.

The charge scaling determination system 320 may be configured to adjust or otherwise transform the resultant parameter combination of vehicle data associated with a given portion of a geographic region of interest. For example, charge scaling determination system 320 may scale the parameter combination of vehicle data for the given portion of the geographic region of interest based on a number of electric vehicle chargers in the given portion. In an embodiment, charge scaling determination system 320 determines a scaled charging number within a range (e.g., between 0 and 1, between 0.01 and 0.95, etc.) for each portion of a geographic region of interest. The scaled charging number may be representative of a quantity of existing chargers (e.g., fast chargers) in the portioned area. The scaled charging number for a given portioned area may then be used to adjust the parameter combination of vehicle data for the portioned area. For instance, the parameter combination of vehicle data for a given portioned area can be multiplied by the scaled charging number determined for that given portioned area.

The activity score generation system 325 may be configured to receive data from the charge scaling determination system 320. This data can include, for example, the scaled parameter combination of vehicle data for respective portioned areas within the geographic region of interest. The activity score generation system 325 may be configured to ultimately generate the vehicle activity scores 145 as an output. As described herein, a vehicle activity score can be a measure that represents or otherwise quantifies vehicle operational activity in the geographic region of interest. For example, the vehicle operational activity determined by the activity score generation system 325 may be quantified in terms of one or more of a level of vehicle movement, a level of vehicle stopping (e.g., for parking and/or charging events), a level of traveling to particular destination locations, or level of other vehicle activity.

The activity score generation system 325 may be configured to generate vehicle activity scores 145 that are indexed by locations over the geographic region of interest. For example, activity score generation system 325 may index vehicle activity scores 145 based on parking event locations. The parking event locations can represent the one or more locations of the one or more vehicles 110 during the one or more parking events determined by parking event determination system 305. Activity score generation system 325 may index vehicle activity scores 145 based on respective locations associated with one or more points of interest. Activity score generation system 325 may be configured to generate vehicle activity scores 145 by fitting the vehicle activity scores to a probability distribution (e.g., a normal distribution or bell curve). Although FIG. 3 depicts generation of vehicle activity scores 145 by vehicle activity system 300, it should be appreciated that vehicle activity system 300 can additionally, or alternatively, be configured to generate other measures such as but not limited to vehicle activity categories, rankings, ratings, and the like.

FIG. 4 depicts a diagram of an example activity clustering system 328 according to example embodiments hereof. The activity clustering system 328 may be implemented, for example, in computing system 116, on-board computing system 210, and/or remote computing system 250. The activity clustering system 328 may include an activity clustering model 150 according to example embodiments hereof. The activity clustering model 150 describes a relationship between the vehicle activity scores 145 received as input and one or more vehicle activity clusters 155 provided as output. Each vehicle activity cluster 155 of the one or more vehicle activity clusters 155 identifies a respective association of vehicle activities. The activity clustering model 150 may be configured to generate, using the activity clustering model 150 and based on the vehicle activity scores 145, one or more vehicle activity clusters 155 associated with respective one or more points of interest. Activity clustering model 150 may include, access, or otherwise leverage a cluster generation system 330, a cluster filtering system 335, and a cluster ranking system 340. In an embodiment, one or more of these systems can be implemented as one or more portions, components, layers, or sub-models of the activity clustering model 150. Additionally, or alternatively, one or more one or more of these systems can be implemented as systems that are separate, accessible systems.

The activity clustering model 150 can be structured in a variety of manners. In an embodiment, activity clustering model 150 may be or may include a rules-based algorithm embodied in computer code commands. Additionally, or alternatively, activity clustering model 150 may be or may otherwise include various machine-learned models such as neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

The cluster generation system 330 may be configured to analyze the vehicle activity scores 145 received from vehicle activity model 140 and to generate vehicle activity clusters 155 respectively corresponding to locations (e.g., points of interest). Cluster generation system 330 may be configured to employ one or more clustering algorithms to generate vehicle activity clusters 155. Example clustering algorithms employed by cluster generation system 330 may include one or more of a K-Means clustering algorithm, a mean-shift clustering algorithm, a hierarchical clustering algorithm (e.g., hierarchical agglomerative clustering (HAC)), clustering based on Gaussian mixture models (GMM) techniques, a spectral clustering algorithm, or other suitable algorithms.

The cluster filtering system 335 may be configured to filter vehicle activity clusters based on a nearness threshold of corresponding points of interest associated with the vehicle activity clusters. For example, cluster filtering system 335 may filter vehicle activity clusters corresponding to points of interest based on a location of the one or more points of interest respectively being within a nearness threshold of a highway within the geographic region of interest. The nearness threshold employed by cluster filtering system 335 may correspond to a particular distance measured, for example, in miles or kilometers (e.g., 2 km, 5 km, 1 mile, 3 miles). As such, cluster filtering system 335 may filter out points of interest that are not within a nearby proximity of a highway or other readily accessible travelway.

The cluster ranking system 340 may be configured to rank the vehicle activity clusters generated by cluster generation system 330 (and optionally filtered by cluster filtering system 335) based on the vehicle activity scores 145. For example, cluster ranking system 340 may determine a ranking for the vehicle activity clusters 155 based on respective points of interest associated with the vehicle activity clusters 155. The cluster ranking system 340 may be configured to determine a ranking of the one or more points of interest indicative of a desirability of building an electric vehicle charging station at the one or more points of interest. In this way, cluster ranking system 340 may be configured to consider both a density of vehicle activity as well as an existing charging infrastructure in respective areas.

In an embodiment, cluster ranking system 340 may be configured to determine a ranking value, such as but not limited to a ranking score, a ranking range, a ranking label, and/or the like. Cluster ranking system 340 may generate a ranking score for vehicle activity clusters and/or corresponding points of interest that are within a predetermined range (e.g., a score between 1 and 10, with 10 being highest priority and 1 being lowest priority). Cluster ranking system 340 may generate a ranking range for vehicle activity clusters and/or corresponding points of interest. For instance, ranking ranges may correspond to a first category of scores between 0-3, a second category of scores between 4-7, and a third category of scores between 8-10. Cluster ranking system 340 may generate a ranking label corresponding to different priority levels (e.g., a “No Priority” label, a “Low Priority” label, and a “Priority” label). For such ranking labels, “No Priority” may be indicative of very limited charging demand in an area predicting no immediate infrastructure action to be taken. A “Low Priority” label may be indicative of limited charging potential, but not implying need for immediate infrastructure action to be taken. A “Priority” or “High Priority” label may be indicative of an optimal or highest predicted charging demand, implying potential for short-term infrastructure implementation to be considered and/or implemented.

FIG. 5 depicts a diagram of an example charging activity prediction system 350 according to example embodiments hereof. The charging activity prediction system 350 may be implemented, for example, in computing system 116, on-board computing system 210, and/or remote computing system 250. The charging activity prediction system 350 may include a charging activity prediction model 160 according to example embodiments hereof. The charging activity prediction model 160 may be configured to receive the vehicle activity clusters 155 from activity clustering model 150 (as well as additional optional inputs such as vehicle activity scores 145, map data 128, point of interest data 130, and/or charging station data 132) and generate one or more charging activity outputs 165. One example charging activity output 165 may provide a prediction associated with building a new electric vehicle charging station at the one or more points of interest. Another example charging activity output 165 may provide a prediction associated with charging an electric vehicle at an existing electric vehicle charging station. Example charging activity outputs 165 may additionally or alternatively include one or more map outputs. As described herein, the map outputs may include a heat map output that provides a visualization of the geographic region of interest and/or map data associated with the one or more vehicle activity clusters for one or more of the points of interest.

In an embodiment, charging activity prediction model 160 may be or may include a rules-based algorithm embodied in computer code commands. In another embodiment, charging activity prediction model 160 may be or may otherwise include various machine-learned models such as neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

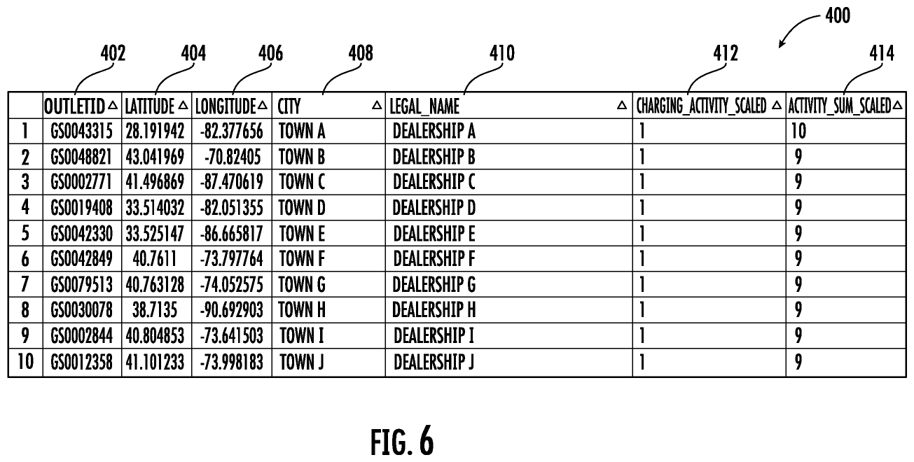

FIGS. 6-11 depict example charging activity outputs 165 according to example embodiments hereof. For example, FIG. 6 depicts an example ranking 400 of activity clusters associated with points of interest according to example embodiments of the present disclosure. Ranking 400 of FIG. 6 includes an ordered list of point of interests within a given geographic area (e.g., a particular country or state). For ease of illustration, ranking 400 of FIG. 6 may include only a portion of an ordered list corresponding to those points of interest obtaining a highest score.

Example points of interest depicted in ranking 400 may be indicated by various identifiers. The identifier may include an internal reference number 402 (OutletID), a latitude value 404, a longitude value 406, a town/city identifier 408, a point of interest name (legal name) 410, a scaling multiplier for existing charging activity (charging_activity_scaled) 412, and/or a vehicle activity scoring value (activity_sum_scaled) 414. The points of interest identified in ranking 400 can be indicative of predictions associated with building an electric vehicle charging station at the one or more highest ranked points of interest. In some implementations, additional operations may be implemented before selecting the ranked points of interest to include in an infrastructure implementation plan for building locations of new electric vehicle charging stations. For example, additional operations may include determining available space for parking and installation at the respective points of interest within ranking 400, determining grid capacity and connection parameters for the respective points of interest within ranking 400, etc.

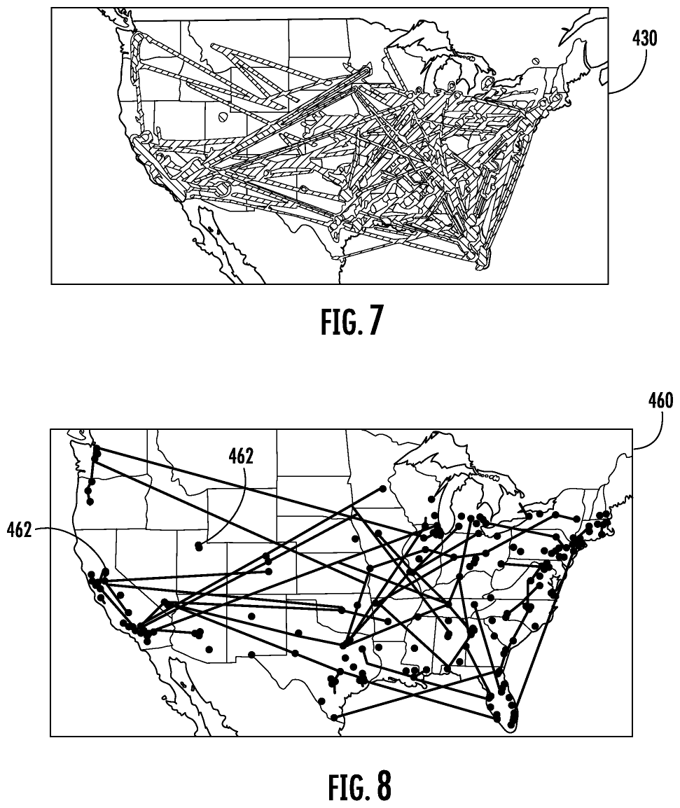

FIGS. 7-11 depict various example output maps according to example embodiments of the present disclosure. One or more of the example outputs maps of FIGS. 7-11 are heat maps that respectively provide a visualization of the geographic region of interest 112 and map data associated with the one or more vehicle activity clusters associated with one or more of the points of interest. Color representations may be presented in grayscale for reproduction and example purposes only. One of ordinary skill in the art will understand that the output maps described herein can be generated with a full color scale.

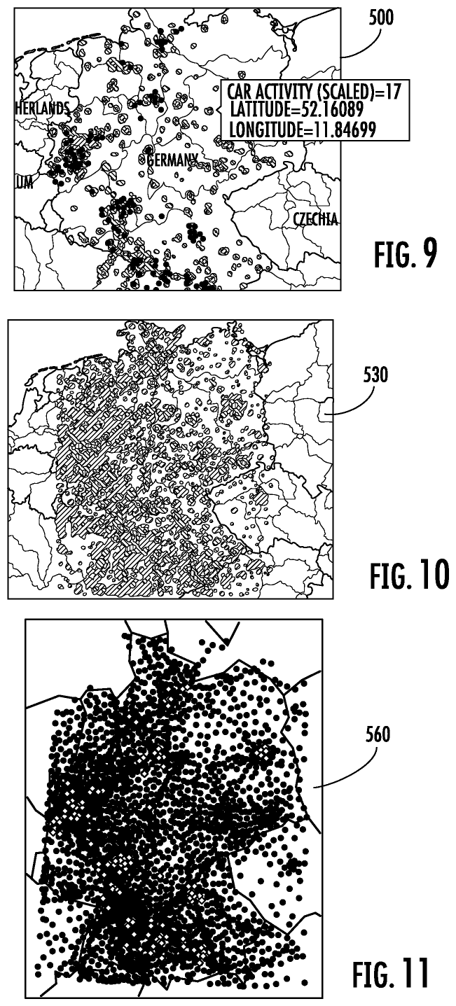

FIGS. 7-11 may provide output maps that present a variety of information generated by the systems and processes described herein. FIG. 7 depicts a heatmap 430 with vehicle activity scores visually depicted by color (e.g., shown in grayscale) and density variation across a geographic region (e.g., a country such as the United States of America). FIG. 8 depicts a heatmap 460 with a depiction of vehicle activity scores similar to heatmap 430 but with determined activity clusters 462 corresponding to respective points of interest overlaid thereon. FIG. 9 depicts a heatmap 500 depicting vehicle activity data associated with a fleet of electric vehicles (e.g., a plurality of EVs associated with a given vehicle manufacturer). The heatmap 500 includes the vehicle activity data visually depicted by color (e.g., shown in grayscale) and density variation across a geographic region (e.g., a country such as Germany). FIG. 10 depicts a heatmap 530 depicting parking event data for a fleet of vehicles (e.g., a fleet of vehicles associated with a given vehicle manufacturer) overlaid with high power charging station availability in a given geographic region. FIG. 11 depicts a heatmap 560 depicting vehicle activity clusters matched to nearby points of interest (e.g., retailers) to generate respective vehicle activity scores.

As can be appreciated from the various examples of FIGS. 7-11, the vehicle activity scores, vehicle activity clusters, and charging activity predictions determined in accordance with the disclosed technology can provide a wide variety of useful information and infrastructure planning data. In general, the visualizations offered by the output maps of FIGS. 7-11 are visually indicative of an overall effect of vehicle activity on geographic locations. For instance, high activity locations may generally be considered as better planned locations for EV charging stations, while low activity locations may be less desirable for building new EV charging stations. Similarly, short distance vehicle activity may prioritize urban areas, while long distance vehicle activity may prioritize points of interest along highways or other travelways as higher ranked locations for building new EV charging stations. The output maps of FIGS. 7-11 ultimately provide valuable high-level visualizations and related information by incorporating a step-by-step merging of data sources and optimized algorithms in accordance with the disclosed technology.

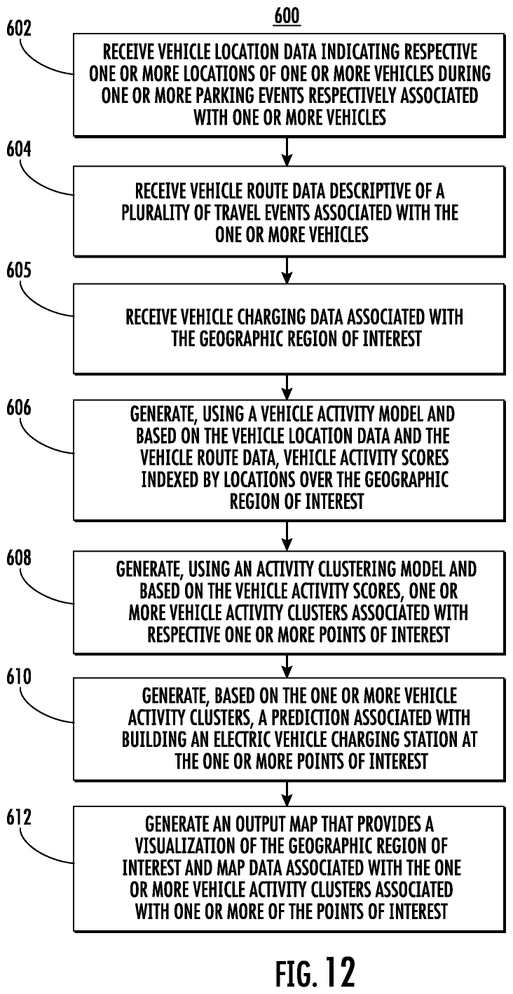

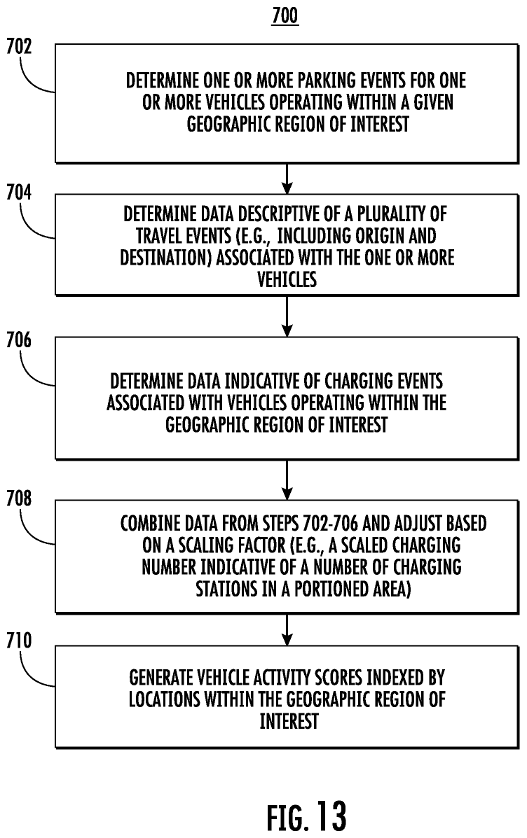

FIG. 12 depicts a flowchart diagram of an example method 600 for clustering vehicle activity data for vehicle activity within a geographic region of interest according to example embodiments of the present disclosure. The method 600 may be performed by a computing system described with reference to the other figures. In an embodiment, the method 600 may be performed by the control circuit 254 of the computing system 250 of FIG. 2 or the computing system 116 of FIG. 1. One or more portions of the method 600 may be implemented as an algorithm on the hardware components of the devices described herein (e.g., as in FIGS. 1, 2, 16 etc.). For example, the steps of method 600 may be implemented as operations/instructions that are executable by computing hardware.

FIG. 12 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 12 is described with reference to elements/terms described with respect to other systems and figures for example illustrated purposes and is not meant to be limiting. One or more portions of method 600 may be performed additionally, or alternatively, by other systems. For example, method 600 may be performed by a control circuit of the computing systems 116, 210 and/or 250.

In an embodiment, the method 600 may begin with or otherwise include a step 602, in which the computing system 116 receives vehicle location data (e.g., vehicle location data 120) indicating respective one or more locations of one or more vehicles (e.g., vehicles 110) during one or more parking events respectively associated with the one or more vehicles. For example, the vehicle location data received at step 602 may be determined in part from sensor output associated with positioning system 216. The positioning system 216 may be any suitable positioning system and/or combinations thereof. As one example, the positioning system 216 may be or may include a satellite positioning system, such as GPS or GLONASS. As another example, the positioning system 216 may output position data describing geographic coordinates (e.g., latitude/longitude) or more granular locations (e.g., travelway segments and/or parking area locations at which the vehicle 110 is located or positioned within. For instance, the positioning system 216 may compare coordinates (e.g., satellite coordinates) of the vehicle 110 to coordinates associated with travelway segments or parking area partitions to identify which segments/partitions the vehicle 110 is positioned within.

In an embodiment, the method 600 may include a step 604, in which the computing system 116 receives vehicle route data (e.g., vehicle route data 122) descriptive of a plurality of travel events associated with the one or more vehicles (e.g., vehicles 110). The vehicle route data received at 604 may indicate, for a respective travel event of the plurality of travel events, a respective origin and a respective destination. In an embodiment, the vehicle route data received at step 604 may be further indicative of a quantity of times that the plurality of travel events include travel between the respective origin and the respective destination.

In an embodiment, the method 600 may include a step 605, in which the computing system 116 receives vehicle charging data 124 associated with the geographic region of interest 112. The vehicle charging data utilized at step 605 may be correlated with the vehicle location data received at step 602. In an embodiment, the vehicle charging data received at 605 includes vehicle range data associated with a battery range of the one or more vehicles 110.

In an embodiment, the method 600 may include a step 606, in which the computing system 116 generates vehicle activity scores 145, using a vehicle activity model 140 and based on the vehicle location data 120, the vehicle route data 122, and/or the vehicle charging data 124, wherein the generated vehicle activity scores 145 are indexed by locations over the geographic region of interest 112. The vehicle activity scores generated at step 606 can be a measure that represents or otherwise quantifies vehicle operational activity in the geographic region of interest.

The vehicle activity model 140 utilized in step 606 may describe a relationship between one or more vehicle parameters received as input and a vehicle activity metric (e.g., vehicle activity scores) provided as output. The one or more vehicle parameters may include the vehicle location data 120, the vehicle route data 122, and/or the vehicle charging data 124.

In an embodiment, the locations by which the vehicle activity scores are indexed in step 606 may include the one or more locations of the one or more vehicles during the one or more parking events. In an embodiment, the locations by which the vehicle activity scores are indexed in step 606 may include one or more respective locations of the one or more points of interest. In an embodiment, the vehicle activity model 140 utilized in step 606 may be configured to generate the vehicle activity scores by fitting the vehicle activity scores to a probability distribution (e.g., a normal or bell curve distribution). More particular aspects of step 606 of FIG. 12 are described herein relative to FIG. 13.

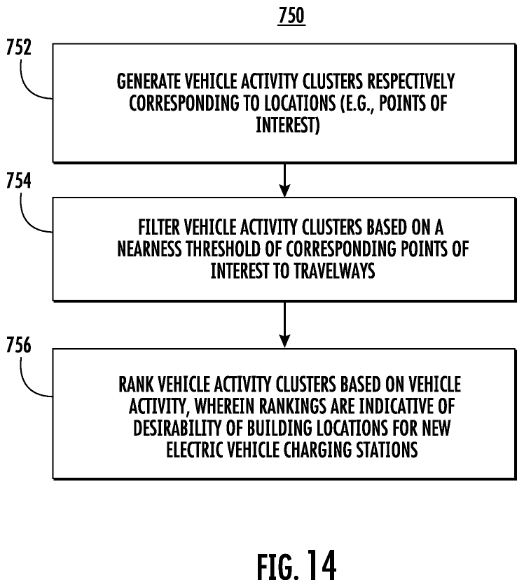

In an embodiment, the method 600 may include a step 608, in which the computing system 116 generates, using an activity clustering model 150 and based on the vehicle activity scores 145, one or more vehicle activity clusters 155 associated with respective one or more points of interest. The activity clustering model 150 utilized at step 608 may describe a relationship between the vehicle activity scores 145 received as input and the one or more vehicle activity clusters 155 provided as output, wherein each vehicle activity cluster of the one or more vehicle activity clusters identifies a respective association of vehicle activities. As described herein, the vehicle activity clusters 155 may include a group of parking events or other vehicle actions that are clustered based on similarities or patterns in the corresponding datapoints. For example, the computing system 116 can process the vehicle activity scores 145 to group similar data points together and distinguish dissimilar data points. In an embodiment, a given point of interest is considered a centroid of an activity cluster, and parking events or other vehicle activity events within a threshold distance (e.g., 2 km) of the given point of interest are clustered together into a vehicle activity cluster 155. In an embodiment, a Haversine distance metric may be employed to determine parking events or other vehicle activity events that are within the threshold distance from a POI or other centroid. More particular aspects of step 608 of FIG. 12 are described herein relative to FIG. 14.

In an embodiment, the method 600 may include a step 610, in which the computing system 116 generates, based on the one or more vehicle activity clusters 155 generated at step 620, a prediction associated with building an electric vehicle charging station at the one or more points of interest. In an embodiment, the one or more points of interest for which predictions are generated at step 610 may include at least one of a vehicle dealership location, a shopping location, or a parking area location. One example prediction generated at 610 may be a prediction associated with building a new electric vehicle charging station at the one or more points of interest. For example, a prediction associated with building a new electric vehicle charging station may be indicative of how much a charging station will be used if it is built at a particular location (e.g., a location of a point of interest for co-location with a new charging station). Another example prediction generated at 610 may be a prediction associated with charging an electric vehicle at an existing electric vehicle charging station. For example, a prediction associated with charging an electric vehicle may be indicative of historic demand associated with a charging station, real-time or current availability at a charging station, and/or likelihood of utilization for a next charging activity at a charging station.

In an embodiment, the method 600 may include a step 612, in which computing system 116 generates an output map that provides a visualization of the geographic region of interest and map data associated with the one or more vehicle activity clusters associated with one or more of the points of interest. The output maps generated at step 612 can correspond, for example, to the heat maps depicted in FIGS. 7-11 or other output maps.

FIG. 13 depicts a flowchart diagram of an example method 700 for generating vehicle activity scores according to example embodiments hereof. One or more parts of method 700 can be utilized as part of step 606 of FIG. 12. The method 700 may be performed by a computing system described with reference to the other figures. In an embodiment, the method 700 may be performed by the control circuit 254 of the computing system 250 of FIG. 2 or the computing system 116 of FIG. 1. One or more portions of the method 700 may be implemented as an algorithm on the hardware components of the devices described herein (e.g., as in FIGS. 1, 2, 16 etc.). For example, the steps of method 700 may be implemented as operations/instructions that are executable by computing hardware.

FIG. 13 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 13 is described with reference to elements/terms described with respect to other systems and figures for example illustrated purposes and is not meant to be limiting. One or more portions of method 700 may be performed additionally, or alternatively, by other systems. For example, method 700 may be performed by a control circuit of the computing systems 116, 210 and/or 250.

In an embodiment, the method 700 may begin with or otherwise include a step 702, in which the computing system 116 determines one or more parking events for one or more vehicles 110 operating within a given geographic region of interest 112. One or more parking events may be determined at step 702 by identifying locations at which a vehicle 110 has been powered off and/or stopped moving for greater than a threshold time duration. Locations at which a vehicle has stopped moving can be determined, for example, by comparing GPS pings and corresponding time stamps in between. When GPS location does not change for longer than a threshold number of successive timestamps, a parking event can be designated at the corresponding GPS location. The threshold time duration may be a quantity of hours, minutes, and/or seconds during which the vehicle 110 is not actively moving. Parking events may be determined at step 702 additionally, or alternatively, based on a determination of vehicle position being within an area known to correspond to a parking area (e.g., parking lot, parking garage, areas close to shopping locations but not on travelways, etc.). Parking events determined at step 702 may be assigned a location-based identifier (GPS coordinates, latitude/longitude, nearest point of interest, etc.) for respectively identified parking events. In an embodiment, parking events determined at step 702 may include one or more time stamps or time durations associated with the parking event (e.g., a length of time during which a vehicle 110 has stopped actively moving).

In an embodiment, step 702 includes determining a number of parking events associated with different portions of a given geographic region of interest. For example, the geographic region of interest 112 may be partitioned into different discrete regions (e.g., a grid of polygons corresponding to one or more particular shapes and/or corresponding sizes). The geographic region of interest 112 may be partitioned into regions based on points of interest within the geographic region of interest 112 (e.g., regions defined by a radius surrounding respective points of interest, such as points of interest defined within point of interest data 130). For instance, geographic region of interest 112 may correspond to distinct regions corresponding to an X-distance radius around respective points of interest within the region. The X-distance radius may be measured in terms of any particular distance dimension, such as meters (m), kilometers (km), feet (ft.), yards (yds.), miles (mi.), etc. The specific number X-distance of meters defining a radius around each point of interest may be fixed across the region or may vary, for example, based on density of vehicles, points of interest, travelways, or other infrastructure within the region. The distance value X defining a radius around each point of interest may be a specific number (e.g., 10 meters, 100 meters, 500 meters, 1 km) or may be indicative of a specific range, for example, between 0 meters and 1000 meters, between 1 meter and 10 meters, between 5 meters and 100 meters, or other specific ranges). Parking events can be determined at step 702 to include a number of parking events occurring within the radius (or radius range) defined around respective points of interest within the given geographic region of interest. Such a determination in step 702 can thus have the effect of determining a number of parking events associated with different regions grouped by a GPS latitude/longitude coordinate rounded to a nearest decimal place (e.g., 4 decimal places).

The method 700 in an embodiment may include a step 704, in which the computing system 116 determines the data descriptive of a plurality of travel events associated with the one or more vehicles 110. The data descriptive of the plurality of travel events may include, for example, a respective origin and a respective destination for each travel event. In an embodiment, step 704 may include determining data indicative of a quantity of times that the plurality of travel events include an instance of travel between the respective origin and the respective destination. For example, given a particular point of interest located in Town A, step 704 may include determining a frequency or quantity of times that vehicles 110 have traveled between Town A and other towns (e.g., Town B, Town C, . . . Town N) within a geographic region of interest. Consideration of route frequency between a current city and other nearby cities can serve as a useful indicator contributing to the overall vehicle activity metric generated by vehicle activity model 140.

The method 700 in an embodiment may include a step 706, in which the computing system 116 determines data indicative of charging events associated with the one or more vehicles 110 operating within the geographic region of interest 112. In some instances, the vehicle charging data determined at 706 may be correlated with the vehicle location data determined at 702 (e.g., for parking events that are also characterized as vehicle charging events). The vehicle charging data determined at 706 may additionally or alternatively include vehicle range data associated with a battery range of the one or more vehicles 110.

The method 700 in an embodiment may include a step 708, in which the computing system 116 combines and scales respective parameters variously determined at steps 702-706. For example, step 708 may include determining a parameter combination of vehicle data. For example, the parameter combination of vehicle data determined at step 708 can correspond to a combination of (e.g., a sum of): (i) a number of parking events per portion of the geographic region of interest as determined at step 702; (ii) a number of times a route between a current (origin) city and other (destination) cities are traveled as determined at step 704; and (iii) a number of times an EV is within an approximate portion of a geographic region of interest (e.g., a 10-meter radius of a point of interest) based on battery range of the EV as determined at step 706.

In an embodiment, step 708 may include adjusting or otherwise transforming the resultant parameter combination of vehicle data associated with a given portion of a geographic region of interest. For example, step 708 may include scaling the parameter combination of vehicle data for the given portion of the geographic region of interest based on a number of electric vehicle chargers in the given portion. In an embodiment, step 708 includes determining a scaled charging number within a range (e.g., between 0 and 1, between 0.01 and 0.95, etc.) for each portion of a geographic region of interest. The scaled charging number may be a quantified metric representative of a quantity of existing chargers (e.g., fast chargers) in the portioned area. For example, if a parameter combination of vehicle data is associated with POI A in Town X, and Town X has little charging activity, the scaled charging number may correspond to a high value within the range such as 0.95. Conversely, if a parameter combination of vehicle data is associated with POI B in Town Y, and Town Y already has significant charging activity, the scaled charging number may correspond to a low value within the range such as 0.01. The scaled charging number for a given portioned area then may be used to adjust the parameter combination of vehicle data for the portioned area. For instance, the parameter combination of vehicle data for a given portioned area can be multiplied by the scaled charging number determined for that given portioned area. The effect of adjusting parameter combinations of vehicle data by a scaled charging number associated with the corresponding region of interest is to reward POIs/locations that may need more charging stations while discounting POIs/locations that already have a substantial number of charging stations.

The method 700 in an embodiment may include a step 710, in which the computing system 116 generates vehicle activity scores 145 as an output. Step 710 may include generating vehicle activity scores 145 that are indexed by locations over the geographic region of interest. For example, step 710 may include indexing vehicle activity scores 145 based on parking event locations (e.g., the one or more locations of the one or more vehicles 110 during the one or more parking events determined by parking event determination system 305). Step 710 may alternatively include indexing vehicle activity scores 145 based on respective locations associated with one or more points of interest. In an embodiment, step 710 may be configured to generate vehicle activity scores 145 by fitting the vehicle activity scores to a probability distribution (e.g., a normal distribution or bell curve).

FIG. 14 depicts a flowchart diagram of an example method 750 for generating vehicle activity clusters according to example embodiments hereof. One or more parts of method 750 can be utilized as part of step 608 of FIG. 12. The method 750 may be performed by a computing system described with reference to the other figures. In an embodiment, the method 750 may be performed by the control circuit 254 of the computing system 250 of FIG. 2 or the computing system 116 of FIG. 1. One or more portions of the method 750 may be implemented as an algorithm on the hardware components of the devices described herein (e.g., as in FIGS. 1, 2, 16 etc.). For example, the steps of method 750 may be implemented as operations/instructions that are executable by computing hardware.

FIG. 14 depicts elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 14 is described with reference to elements/terms described with respect to other systems and figures for example illustrated purposes and is not meant to be limiting. One or more portions of method 750 may be performed additionally, or alternatively, by other systems. For example, method 750 may be performed by a control circuit of the computing systems 116, 210 and/or 250.

In an embodiment, the method 750 may begin with or otherwise include a step 752, in which the computing system 116 generates vehicle activity clusters 155 respectively corresponding to locations (e.g., points of interest). Vehicle activity clusters 155 determined at step 752 may be based on the vehicle activity scores 145 and an activity clustering model 150. Vehicle activity clusters determined at step 752 may be determined on one or more clustering algorithms, such as but not limited to one or more of a K-Means clustering algorithm, a mean-shift clustering algorithm, a hierarchical clustering algorithm (e.g., hierarchical agglomerative clustering (HAC)), clustering based on Gaussian mixture models (GMM) techniques, a spectral clustering algorithm, or other suitable algorithms.

In an embodiment, the method 750 may include a step 754, in which the computing system 116 filters vehicle activity clusters based on a nearness threshold of corresponding points of interest associated with the vehicle activity clusters. For example, cluster filtering implemented at step 754 may include filtering vehicle activity clusters corresponding to points of interest based on a location of the one or more points of interest respectively being within a nearness threshold of a highway within the geographic region of interest. For example, if the point of interest serving as the centroid for an activity cluster is not within a threshold distance (e.g., 2 km) of a highway or other major travelway, then the vehicle activity cluster corresponding to that POI may be filtered out. The nearness threshold used in step 754 may correspond to a particular distance measured, for example, in miles or kilometers (e.g., 2 km, 5 km, 1 mile, 3 miles). As such, points of interest can be filtered out at step 754 that are not within nearby proximity of a highway or other readily accessible travelway.

In an embodiment, the method 750 may include a step 756, in which the computing system 116 ranks the vehicle activity clusters generated at step 752 and optionally filtered at step 754 based on the vehicle activity scores 145. For example, a ranking for the vehicle activity clusters may be determined at step 756 based on respective points of interest associated with the vehicle activity clusters 155. A ranking of the one or more points of interest as determined at step 756 may be indicative of a desirability of building an electric vehicle charging station at the one or more points of interest. In this way, ranking implemented at step 756 may be configured to consider both a density of vehicle activity as well as an existing charging infrastructure in respective areas.

In an embodiment, ranking determined at step 756 may include determining a ranking value, such as but not limited to a ranking score, a ranking range, a ranking label, and/or the like. For example, in an embodiment, rankings determined at step 756 may include a ranking score for vehicle activity clusters and/or corresponding points of interest that are within a predetermined range (e.g., a score between 1 and 10, with 10 being highest priority and 1 being lowest priority). In an embodiment, rankings determined at step 756 may include a ranking range for vehicle activity clusters and/or corresponding points of interest. For instance, ranking ranges may correspond to a first category of scores between 0-3, a second category of scores between 4-7, and a third category of scores between 8-10. In an embodiment, rankings determined at step 756 may include a ranking label corresponding to different priority levels (e.g., a “No Priority” label, a “Low Priority” label, and a “Priority” label), as described herein.

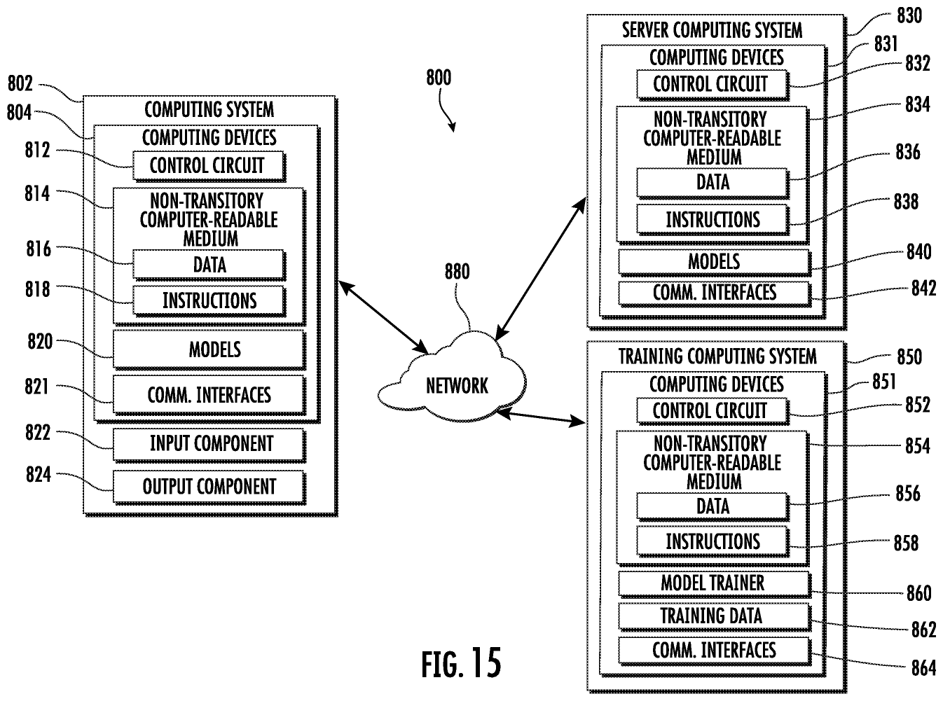

FIG. 15 depicts a block diagram of an example computing system 800 that performs vehicle activity score determination, vehicle clustering, and/or charging activity prediction according to example embodiments hereof. The system 800 includes a computing system 802 (e.g., a computing system onboard a vehicle), a server computing system 830 (e.g., a remote computing system), and a training computing system 850 that are communicatively coupled over a network 880.

The computing system 802 may include one or more computing devices 804 or circuitry. For instance, the computing system 802 may include a control circuit 812 and a non-transitory computer-readable medium 814. In an embodiment, the control circuit 812 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 812 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller (CDCC), a central exterior & interior controller (CEIC), a zone controller, or any other controller. In an embodiment, the control circuit 812 may be programmed by one or more computer-readable or computer-executable instructions stored on the non-transitory computer-readable medium 814.

In an embodiment, the non-transitory computer-readable medium 814 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 814 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 814 may store information that may be accessed by the control circuit 812. For instance, the non-transitory computer-readable medium 814 (e.g., memory devices) may store data 816 that can be obtained, received, accessed, written, manipulated, created, and/or stored. The data 816 can include, for instance, any of the data or information described herein. In some implementations, the computing system 802 can obtain data from one or more memories that are remote from the computing system 802.

The non-transitory computer-readable medium 814 may also store computer-readable instructions 818 that can be executed by the control circuit 812. The instructions 818 may be software written in any suitable programming language or can be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 812 to perform one or more functional tasks. The modules and computer-readable/executable instructions may be described as performing various operations or tasks when the control circuit 812 or other hardware component is executing the modules or computer-readable instructions.

The instructions 818 may be executed in logically and/or virtually separate threads on the control circuit 812. For example, the non-transitory computer-readable medium 814 can store instructions 818 that when executed by the control circuit 812 cause the control circuit 812 to perform any of the operations, methods and/or processes described herein. In some cases, the non-transitory computer-readable medium 814 may store computer-executable instructions or computer-readable instructions, such as instructions to perform at least a portion of the methods of FIGS. 12-14.

In an embodiment, the computing system 802 may store or include one or more machine-learned models 820. For example, the machine-learned models 820 may be or may otherwise include various machine-learned models, including the vehicle activity model 140, the activity clustering model 150, and/or the charging activity prediction model 160. In an embodiment, the machine-learned models 820 may include an unsupervised learning model (e.g., for generating activity clusters). In an embodiment, the machine-learned models 820 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

In an embodiment, the one or more machine-learned models 820 may be received from the server computing system 830 over one or more networks 880, stored in the computing system 802 (e.g., non-transitory computer-readable medium 814), and then used or otherwise implemented by the control circuit 812. In an embodiment, the computing system 802 may implement multiple parallel instances of a single model.

Additionally or alternatively, one or more machine-learned models 820 may be included in or otherwise stored and implemented by the server computing system 830 that communicates with the computing system 802 according to a client-server relationship. For example, the machine-learned models 820 may be implemented by the server computing system 830 as a portion of a web service. Thus, one or more models 820 may be stored and implemented at the computing system 802 and/or one or more models 840 may be stored and implemented at the server computing system 830.

The computing system 802 may include a communication interface 821. The communication interface 821 may be used to communicate with one or more other systems. The communication interface 821 may include any circuits, components, software, etc. for communicating via one or more networks (e.g., networks 880). In some implementations, the communication interface 821 may include for example, one or more of a communications controller, receiver, transceiver, transmitter, port, conductors, software and/or hardware for communicating data/information.

The computing system 802 may also include one or more user input components 822 that receives user input. For example, the user input component 822 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user (e.g., a vehicle operator, passenger, or other user) may provide user input.

The computing system 802 may include one or more output components 824. The output components 824 can include hardware and/or software for audibly or visually producing content. For instance, the output components 824 can include one or more speaker(s), earpiece(s), headset(s), handset(s), etc. The output components 824 can include a display device, which can include hardware for displaying a user interface and/or messages for a user. By way of example, the output component 824 can include a display screen, CRT, LCD, plasma screen, touch screen, TV, projector, tablet, and/or other suitable display components.

The server computing system 830 can include one or more computing devices 831. In an embodiment, the server computing system 830 may include or is otherwise implemented by the one or more server computing devices 831. In instances in which the server computing system 830 includes plural server computing devices, such server computing devices may operate according to sequential computing architectures, parallel computing architectures, or some combination thereof.

The server computing system 830 can include a control circuit 832 and a non-transitory computer-readable medium 834, also referred to herein as memory. In an embodiment, the control circuit 832 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 832 may be programmed by one or more computer-readable or computer-executable instructions stored on the non-transitory computer-readable medium 834.

In an embodiment, the non-transitory computer-readable medium 834 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 834 may store information that may be accessed by the control circuit 832. For instance, the non-transitory computer-readable medium 834 (e.g., memory devices) may store data 836 that can be obtained, received, accessed, written, manipulated, created, and/or stored. The data 836 can include, for instance, any of the data or information described herein. In some implementations, the server computing system 830 can obtain data from one or more memories that are remote from the server computing system 830.

The non-transitory computer-readable medium 834 may also store computer-readable instructions 838 that can be executed by the control circuit 832. The instructions 838 may be software written in any suitable programming language or can be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 832 to perform one or more functional tasks. The modules and computer-readable/executable instructions may be described as performing various operations or tasks when the control circuit 832 or other hardware component is executing the modules or computer-readable instructions.

The instructions 838 may be executed in logically and/or virtually separate threads on the control circuit 832. For example, the non-transitory computer-readable medium 834 can store instructions 838 that when executed by the control circuit 832 cause the control circuit 832 to perform any of the operations, methods and/or processes described herein. In some cases, the non-transitory computer-readable medium 834 may store computer-executable instructions or computer-readable instructions, such as instructions to perform at least a portion of the methods of FIGS. 12-14.

The server computing system 830 may store or otherwise include one or more machine-learned models 840, including the vehicle activity model 140, the activity clustering model 150, and/or the charging activity prediction model 160. The machine-learned models 840 may include or be the same as the models 820 stored in computing system 802. In an embodiment, the machine-learned models 840 can include an unsupervised learning model. In an embodiment, the machine-learned models 840 can include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

The server computing system 830 may include a communication interface 842. The communication interface 842 may be used to communicate with one or more other systems. The communication interface 842 may include any circuits, components, software, etc. for communicating via one or more networks (e.g., networks 880). In some implementations, the communication interface 842 may include for example, one or more of a communications controller, receiver, transceiver, transmitter, port, conductors, software and/or hardware for communicating data/information.

The computing system 802 and/or the server computing system 830 may train the models 820, 840 via interaction with the training computing system 850 that is communicatively coupled over the networks 880. The training computing system 850 may be separate from the server computing system 830 or may be a portion of the server computing system 830.

The training computing system 850 may include one or more computing devices 851. In an embodiment, the training computing system 850 can include or is otherwise implemented by one or more server computing devices. In instances in which the training computing system 850 includes plural server computing devices, such server computing devices may operate according to sequential computing architectures, parallel computing architectures, or some combination thereof.

The training computing system 850 may include a control circuit 852 and a non-transitory computer-readable medium 854, also referred to herein as memory. In an embodiment, the control circuit 852 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 852 may be programmed by one or more computer-readable or computer-executable instructions stored on the non-transitory computer-readable medium 854.

In an embodiment, the non-transitory computer-readable medium 854 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 854 may store information that may be accessed by the control circuit 852. For instance, the non-transitory computer-readable medium 854 (e.g., memory devices) may store data 856 that can be obtained, received, accessed, written, manipulated, created, and/or stored. The data 856 can include, for instance, any of the data or information described herein. In some implementations, the training computing system 850 can obtain data from one or more memories that are remote from the training computing system 850.

The non-transitory computer-readable medium 854 may also store computer-readable instructions 858 that can be executed by the control circuit 852. The instructions 858 may be software written in any suitable programming language or can be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 852 to perform one or more functional tasks. The modules and computer-readable/executable instructions may be described as performing various operations or tasks when the control circuit 852 or other hardware component is executing the modules or computer-readable instructions.

The instructions 858 may be executed in logically and/or virtually separate threads on the control circuit 852. For example, the non-transitory computer-readable medium 854 can store instructions 858 that when executed by the control circuit 852 cause the control circuit 852 to perform any of the operations, methods and/or processes described herein. In some cases, the non-transitory computer-readable medium 854 may store computer-executable instructions or computer-readable instructions, such as instructions to perform at least a portion of the methods of FIGS. 12-14.

The training computing system 850 may include a model trainer 860 that trains the machine-learned models 820, 840 stored at the computing system 802 and/or the server computing system 830 using various training or learning techniques. The model trainer 860 can utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 860 may perform a number of generalization techniques (e.g., weight decays, dropouts, etc.) to improve the generalization capability of a model being trained. In particular, the model trainer 860 may train the machine-learned models 820, 840 based on a set of training data 862.

In an embodiment, if consent/authorization has been provided, the training examples may be provided by the computing system 802. Thus, in such implementations, a model 820 provided to the computing system 802 may be trained by the training computing system 850 in a manner to personalize the model 820.

The model trainer 860 may include computer logic utilized to provide desired functionality. The model trainer 860 may be implemented in hardware, firmware, and/or software controlling a general-purpose processor. For example, in an embodiment, the model trainer 860 may include program files stored on a storage device, loaded into a memory and executed by one or more processors. In other implementations, the model trainer 1440 may include one or more sets of computer-executable instructions that are stored in a tangible computer-readable storage medium such as RAM, hard disk, or optical or magnetic media.

The training computing system 850 may include a communication interface 864. The communication interface 864 may be used to communicate with one or more other systems. The communication interface 864 may include any circuits, components, software, etc. for communicating via one or more networks (e.g., networks 880). In some implementations, the communication interface 864 may include for example, one or more of a communications controller, receiver, transceiver, transmitter, port, conductors, software and/or hardware for communicating data/information.

The networks 880 may be any type of communications network, such as a local area network (e.g., intranet), wide area network (e.g., Internet), or some combination thereof and may include any number of wired or wireless links. In general, communication over the network 880 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may have various types of input data and/or combinations thereof, representing data available to sensors and/or other systems onboard a vehicle. Input data can include, for example, latent encoding data (e.g., a latent space representation of an input, etc.), statistical data (e.g., data computed and/or calculated from some other data source), sensor data (e.g., raw and/or processed data captured by a sensor of the vehicle), or other types of data.

FIG. 15 illustrates one example computing system that may be used to implement the present disclosure. Other computing systems may be used as well. For example, in an embodiment, the computing system 802 may include the model trainer 860 and the training dataset 862. In such implementations, the models 820, 840 may be both trained and used locally at the computing system 802. In some of such implementations, the computing system 802 may implement the model trainer 860 to personalize the models 820.

### Additional Discussion of Various Embodiments

Embodiment 1 relates to a computing system. The computing system may include a control circuit configured to perform operations. The operations may include receiving vehicle location data indicating respective one or more locations of one or more vehicles during one or more parking events respectively associated with the one or more vehicles. The operations may further include receiving vehicle route data descriptive of a plurality of travel events associated with the one or more vehicles. The vehicle route data may indicate, for a respective travel event of the plurality of travel events, a respective origin and a respective destination. The operations may further include generating, using a vehicle activity model and based on the vehicle location data and the vehicle route data, vehicle activity scores indexed by locations over the geographic region of interest. The vehicle activity model may describe a relationship between one or more vehicle parameters received as input and a vehicle activity metric (e.g., vehicle activity scores) generated as output, wherein the one or more vehicle parameters include the vehicle location data and the vehicle route data. The operations may further include generating, using an activity clustering model and based on the vehicle activity scores, one or more vehicle activity clusters associated with respective one or more points of interest. The activity clustering model may describe a relationship between the vehicle activity scores received as input and the one or more vehicle activity clusters provided as output, wherein each vehicle activity cluster of the one or more vehicle activity clusters identifies a respective association of vehicle activities. The operations may further include generating, based on the one or more vehicle activity clusters, a prediction associated with building an electric vehicle charging station at the one or more points of interest.

Embodiment 2 includes the computing system of embodiment 1. In this embodiment, the operations may further include receiving vehicle charging data associated with the geographic region of interest, and the vehicle activity model may be further configured to generate the vehicle activity scores based on the vehicle charging data.

Embodiment 3 includes the computing system of any one of embodiments 1-2. In this embodiment, the vehicle charging data may be correlated with the vehicle location data.

Embodiment 4 includes the computing system of any one of embodiments 1-3. In this embodiment, the locations by which the vehicle activity scores are indexed may include the one or more locations of the one or more vehicles during the one or more parking events.

Embodiment 5 includes the computing system of any one of embodiments 1-4. In this embodiment, the locations by which the vehicle activity scores are indexed may include one or more respective locations of the one or more points of interest.

Embodiment 6 includes the computing system of any one of embodiments 1-5. In this embodiment, the vehicle route data may be further indicative of a quantity of times that the plurality of travel events include travel between the respective origin and the respective destination.

Embodiment 7 includes the computing system of any one of embodiments 1-6. In this embodiment, the operations may further include receiving vehicle range data associated with a battery range of the one or more vehicles, and the vehicle activity model may be further configured to generate the vehicle activity scores based on the vehicle range data.

Embodiment 8 includes the computing system of any one of embodiments 1-7. In this embodiment, the activity clustering model may be further configured to generate the one or more vehicle activity clusters associated with the one or more points of interest by filtering the one or more points of interest based on a location of the one or more points of interest respectively being within a nearness threshold of a highway within the geographic region of interest.

Embodiment 9 includes the computing system of any one of embodiments 1-8. In this embodiment, one or more vehicle activity clusters associated with one or more points of interest may be ranked by the control circuit based on the vehicle activity scores.

Embodiment 10 includes the computing system of any one of embodiments 1-9. In this embodiment, the one or more points of interest may include at least one of a vehicle dealership location or a shopping location.

Embodiment 11 includes the computing system of any one of embodiments 1-10. In this embodiment, the one or more vehicle activity clusters associated with one or more points of interest may include a ranking of the one or more points of interest. The ranking of the one or more points of interest may be indicative of a desirability of building an electric vehicle charging station at the one or more points of interest.

Embodiment 12 includes the computing system of any one of embodiments 1-11. In this embodiment, the vehicle activity model may be configured to generate the vehicle activity scores by fitting the vehicle activity scores to a normal distribution.

Embodiment 13 includes the computing system of any one of embodiments 1-12. In this embodiment, the operations may further include generating a heat map that provides a visualization of the geographic region of interest and map data associated with the one or more vehicle activity clusters associated with one or more of the points of interest.

Embodiment 14 relates to a computer-implemented method. The computer-implemented method may include receiving vehicle location data indicating respective one or more locations of one or more vehicles during one or more parking events respectively associated with the one or more vehicles. The computer-implemented method may also include receiving vehicle route data descriptive of a plurality of travel events associated with the one or more vehicles, the vehicle route data indicating, for a respective travel event of the plurality of travel events, a respective origin and a respective destination. The computer-implemented method may also include generating, using a vehicle activity model and based on the vehicle location data and the vehicle route data, vehicle activity scores indexed by locations over the geographic region of interest. The vehicle activity model may describe a relationship between one or more vehicle parameters received as input and the vehicle activity scores provided as output, wherein the one or more vehicle parameters include the vehicle location data and the vehicle route data. The computer-implemented method may also include generating, using an activity clustering model and based on the vehicle activity scores, one or more vehicle activity clusters associated with respective one or more points of interest. The activity clustering model may describe a relationship between the vehicle activity scores received as input and the one or more vehicle activity clusters provided as output. Each vehicle activity cluster of the one or more vehicle activity clusters may identify a respective association of vehicle activities. The computer-implemented method may also include generating, based on the one or more vehicle activity clusters, a prediction associated with building an electric vehicle charging station at the one or more points of interest.

Embodiment 15 includes the computer-implemented method of embodiment 14. In this embodiment, the computer-implemented method may also include receiving vehicle charging data associated with the geographic region of interest. The vehicle activity model may be further configured to generate the vehicle activity scores based on the vehicle charging data.

Embodiment 16 includes the computer-implemented method of any one or embodiments 14-15. In this embodiment, the vehicle charging data may be correlated with the vehicle location data.

Embodiment 17 includes the computer-implemented method of any one of embodiments 14-16. In this embodiment, the locations by which the vehicle activity scores are indexed may include the one or more locations of the one or more vehicles during the one or more parking events.

Embodiment 18 includes the computer-implemented method of any one of embodiments 14-17. In this embodiment, the locations by which the vehicle activity scores are indexed may include one or more respective locations of the one or more points of interest.

Embodiment 19 includes the computer-implemented method of any one or embodiments 14-18. In this embodiment, the computer-implemented method may also include receiving vehicle range data associated with a battery range of the one or more vehicles. The vehicle activity model may be further configured to generate the vehicle activity scores based on the vehicle range data.

Embodiment 20 relates to one or more non-transitory computer-readable media that store instructions that are executable by a control circuit. The instructions, when executed, may cause the control circuit to perform operations. The operations may include receiving vehicle location data indicating respective one or more locations of one or more vehicles during one or more parking events respectively associated with the one or more vehicles. The operations may further include receiving vehicle route data descriptive of a plurality of travel events associated with the one or more vehicles, the vehicle route data indicating, for a respective travel event of the plurality of travel events, a respective origin and a respective destination. The operations may further include generating, using a vehicle activity model and based on the vehicle location data and the vehicle route data, vehicle activity scores indexed by locations over the geographic region of interest. The vehicle activity model may describe a relationship between one or more vehicle parameters received as input and the vehicle activity scores provided as output, wherein the one or more vehicle parameters include the vehicle location data and the vehicle route data. The operations may further include generating, using an activity clustering model and based on the vehicle activity scores, one or more vehicle activity clusters associated with respective one or more points of interest. The activity clustering model may describe a relationship between the vehicle activity scores received as input and the one or more vehicle activity clusters provided as output. Each vehicle activity cluster of the one or more vehicle activity clusters may identify a respective association of vehicle activities. The operations may further include generating, based on the one or more vehicle activity clusters, a prediction associated with building an electric vehicle charging station at the one or more points of interest.

### Additional Disclosure

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A computing system for clustering vehicle activity data for vehicle activity within a geographic region of interest, the computing system comprising:
a control circuit configured to:
receive vehicle location data indicating respective one or more locations of one or more vehicles during one or more parking events respectively associated with the one or more vehicles;
receive vehicle route data descriptive of a plurality of travel events associated with the one or more vehicles, the vehicle route data indicating, for a respective travel event of the plurality of travel events, a respective origin and a respective destination;
generate, using a vehicle activity model and based on the vehicle location data and the vehicle route data, vehicle activity scores indexed by locations over the geographic region of interest, wherein the vehicle activity model describes a relationship between one or more vehicle parameters received as input and the vehicle activity scores provided as output, wherein the one or more vehicle parameters comprise the vehicle location data and the vehicle route data;
generate, using an activity clustering model and based on the vehicle activity scores, one or more vehicle activity clusters associated with respective one or more points of interest, wherein the activity clustering model describes a relationship between the vehicle activity scores received as input and the one or more vehicle activity clusters provided as output, and wherein each vehicle activity cluster of the one or more vehicle activity clusters identifies a respective association of vehicle activities; and
generate, based on the one or more vehicle activity clusters, a prediction associated with building an electric vehicle charging station at the respective one or more points of interest.

2. The computing system of claim 1, wherein:
the control circuit is further configured to receive vehicle charging data associated with the geographic region of interest; and
the vehicle activity model is further configured to generate the vehicle activity scores based on the vehicle charging data.

3. The computing system of claim 2, wherein the vehicle charging data is correlated with the vehicle location data.

4. The computing system of claim 1, wherein the locations by which the vehicle activity scores are indexed comprise the respective one or more locations of the one or more vehicles during the one or more parking events.

5. The computing system of claim 1, wherein the locations by which the vehicle activity scores are indexed comprise one or more respective locations of the respective one or more points of interest.

6. The computing system of claim 1, wherein the vehicle route data is further indicative of a quantity of times that the plurality of travel events include travel between the respective origin and the respective destination.

7. The computing system of claim 1, wherein:
the control circuit is further configured to receive vehicle range data associated with a battery range of the one or more vehicles; and
the vehicle activity model is further configured to generate the vehicle activity scores based on the vehicle range data.

8. The computing system of claim 1, wherein the activity clustering model is further configured to generate the one or more vehicle activity clusters associated with the respective one or more points of interest by filtering the respective one or more points of interest based on a location of the respective one or more points of interest being within a nearness threshold of a highway within the geographic region of interest.

9. The computing system of claim 1, wherein one or more vehicle activity clusters associated with one or more points of interest are ranked by the control circuit based on the vehicle activity scores.

10. The computing system of claim 1, wherein the respective one or more points of interest comprise at least one of a vehicle dealership location or a shopping location.

11. The computing system of claim 1, wherein the control circuit is configured, when generating the one or more vehicle activity clusters associated with one or more points of interest, to determine a ranking of the respective one or more points of interest, the ranking of the respective one or more points of interest indicative of a desirability of building an electric vehicle charging station at the respective one or more points of interest.

12. The computing system of claim 1, wherein the vehicle activity model is configured to generate the vehicle activity scores by fitting the vehicle activity scores to a normal distribution.

13. The computing system of claim 1, wherein the control circuit is further configured to generate a heat map that provides a visualization of the geographic region of interest and map data associated with the one or more vehicle activity clusters associated with one or more of the points of interest.

14. A computer-implemented method comprising:
receiving vehicle location data indicating respective one or more locations of one or more vehicles during one or more parking events respectively associated with the one or more vehicles operating in a geographic region of interest;
receiving vehicle route data descriptive of a plurality of travel events associated with the one or more vehicles, the vehicle route data indicating, for a respective travel event of the plurality of travel events, a respective origin and a respective destination;
generating, using a vehicle activity model and based on the vehicle location data and the vehicle route data, vehicle activity scores indexed by locations over the geographic region of interest, wherein the vehicle activity model describes a relationship between one or more vehicle parameters received as input and the vehicle activity scores provided as output, wherein the one or more vehicle parameters comprise the vehicle location data and the vehicle route data; and
generating, using an activity clustering model and based on the vehicle activity scores, one or more vehicle activity clusters associated with respective one or more points of interest, wherein the activity clustering model describes a relationship between the vehicle activity scores received as input and the one or more vehicle activity clusters provided as output, and wherein each vehicle activity cluster of the one or more vehicle activity clusters identifies a respective association of vehicle activities; and
generating, based on the one or more vehicle activity clusters, a prediction associated with building an electric vehicle charging station at the respective one or more points of interest.

15. The computer-implemented method of claim 14, comprising:
receiving vehicle charging data associated with the geographic region of interest;
wherein the vehicle activity model is further configured to generate the vehicle activity scores based on the vehicle charging data.

16. The computer-implemented method of claim 15, wherein the vehicle charging data is correlated with the vehicle location data.

17. The computer-implemented method of claim 14, wherein the locations by which the vehicle activity scores are indexed comprise the respective one or more locations of the one or more vehicles during the one or more parking events.

18. The computer-implemented method of claim 14, wherein the locations by which the vehicle activity scores are indexed comprise one or more respective locations of the respective one or more points of interest.

19. The computer-implemented method of claim 14, further comprising:
receiving vehicle range data associated with a battery range of the one or more vehicles; and
wherein the vehicle activity model is further configured to generate the vehicle activity scores based on the vehicle range data.

20. One or more non-transitory computer-readable media that store instructions that are executable by a control circuit to:
receive vehicle location data indicating respective one or more locations of one or more vehicles during one or more parking events respectively associated with the one or more vehicles;
receive vehicle route data descriptive of a plurality of travel events associated with the one or more vehicles, the vehicle route data indicating, for a respective travel event of the plurality of travel events, a respective origin and a respective destination;
generate, using a vehicle activity model and based on the vehicle location data and the vehicle route data, vehicle activity scores indexed by locations over the geographic region of interest, wherein the vehicle activity model describes a relationship between one or more vehicle parameters received as input and the vehicle activity scores provided as output, wherein the one or more vehicle parameters comprise the vehicle location data and the vehicle route data; and
generate, using an activity clustering model and based on the vehicle activity scores, one or more vehicle activity clusters associated with respective one or more points of interest, wherein the activity clustering model describes a relationship between the vehicle activity scores received as input and the one or more vehicle activity clusters provided as output, and wherein each vehicle activity cluster of the one or more vehicle activity clusters identifies a respective association of vehicle activities; and
generate, based on the one or more vehicle activity clusters, a prediction associated with building an electric vehicle charging station at the one or more points of interest.
